(19) United States
(12) Patent Application Publication
(10) Pub. No.: US 2012/0067050 A1
(43) Pub. Date: Mar. 22, 2012

(54) COMPOSITE MAGNETIC RING AND ENERGY CONVERTER

(75) Inventor: Yohtaro Yamazaki, Kanagawa (JP)

(73) Assignee: TOKYO INSTITUTE OF TECHNOLOGY, Tokyo (JP)

(21) Appl. No.: 13/322,241

(22) PCT Filed: May 19, 2010
(86) PCT No.: PCT/JP2010/058846

§ 371 Date: Nov. 23, 2011

(30) Foreign Application Priority Data
May 28, 2009 (JP) 2009-129365

(51) Int. Cl. F03G 7/00; H01F 7/02

(52) U.S. Cl. 60/721; 335/306

(57) ABSTRACT

A composite magnetic ring has a plurality of permanent magnets arranged in a ring shape at a prescribed spacing, and low-temperature Curie point magnetic substances sandwiched between each adjacent permanent magnets. An energy converter, that converts exhaust heat energy or sunlight heat energy to mechanical or electrical energy by alteration of the magnetic permeability of low-temperature Curie point magnetic substances in the composite magnetic ring near their Curie point, includes a composite magnetic ring and a rotor situated inside the composite magnetic ring and having a plurality of magnetic poles, at least one of the low-temperature Curie point magnetic substances in the composite magnetic ring being heated to a temperature near its Curie point and a magnetic field being generated in the vicinity of the heated low-temperature Curie point magnetic substance, to rotate the rotor.

### TECHNICAL FIELD

The present invention relates to a composite magnetic ring that can be used for effective utilization of exhaust heat energy or sunlight heat energy at low temperatures of no higher than 100° C., as mechanical energy or electrical energy, and to an energy converter such as a thermomagnetic motor wherein the variation of magnetic permeabilities of low-temperature Curie point magnetic substances in the composite magnetic ring at a temperature near their Curie point is utilized for efficient conversion of low-temperature exhaust heat energy or sunlight heat energy to mechanical energy or electrical energy.

### BACKGROUND ART

Exhaust heat energy and sunlight heat energy at temperatures of up to 100° C. constitute a major energy source, but they are still not being efficiently utilized as mechanical energy or electrical energy. One strategy for recovering and effectively utilizing exhaust heat energy or sunlight heat energy that has been proposed in the prior art, is to use a thermomagnetic motor (also known as “thermomagnetic engine) wherein the variation in magnetic permeability at a temperature near the Curie point of a soft magnetic material (for example, a low-temperature Curie point magnetic substance) is utilized for conversion of exhaust heat energy or sunlight heat energy to mechanical energy. A “thermomagnetic motor” is a device that employs a magnetic circuit comprising a soft magnetic material and a permanent magnet, whose magnetic properties vary depending on temperature, for efficient conversion of low-temperature exhaust heat energy or sunlight heat energy to mechanical energy.

A conventional thermomagnetic motor, such as disclosed, for example, in Non-patent document 1 mentioned below, is provided with a rotor having a disc-shaped soft magnetic material comprising a low-temperature Curie point magnetic substance such as a magnetic shunt alloy, and a stator comprising a permanent magnet for application of an external magnetic field. When certain regions of the disc-shaped soft magnetic material composing the principal part of the rotor are heated to form high temperature sections while the other regions of the disc-shaped soft magnetic material are cooled to form low temperature sections, a temperature difference is produced in the disc-shaped soft magnetic material. Generally speaking, a disc-shaped soft magnetic material such as a magnetic shunt alloy undergoes an abrupt reduction in magnetic permeability as the Curie point is approached, in the region of lower temperature than the Curie point. Consequently, the magnetic permeability at the high temperature sections of the disc-shaped soft magnetic material is a much lower value than the magnetic permeability at the low temperature sections. When an external magnetic field is applied roughly perpendicular to the interface between the high temperature section and the low temperature section of the disc-shaped soft magnetic material, by the permanent magnet of the stator, a force is generated which attracts the low temperature section of the disc-shaped soft magnetic material, which has high magnetic permeability, in the direction of the high temperature section of the disc-shaped soft magnetic material, which has low magnetic permeability. As a result, rotary force (driving force) is generated to rotate the rotor in the direction from the low temperature section to the high temperature section of the disc-shaped soft magnetic material, and the rotor rotates by this rotary force.

In this type of conventional thermomagnetic motor, a portion of the disc-shaped soft magnetic material is sandwiched between the magnetic poles of the permanent magnet of the stator, and the portion of the disc-shaped soft magnetic material in the region with a large magnetic field gradient becomes heated. Heat therefore flows from the high temperature section to the low temperature section of the disc-shaped soft magnetic material, thus preventing adequate heating of the disc-shaped soft magnetic material. On the other hand, since the size of the disc-shaped soft magnetic material is limited to the structure of a conventional thermomagnetic motor, it has not been possible to obtain very large spacing between the high temperature section and the low temperature section of the disc-shaped soft magnetic material. In addition, in order to obtain a large rotary force it is necessary to increase the temperature gradient at the boundary between the high temperature section and the low temperature section of the disc-shaped soft magnetic material, in order to increase the difference in the magnetic permeability between the high temperature section and low temperature section of the disc-shaped soft magnetic material. The heat loss is therefore increased due to the flow of heat when the disc-shaped soft magnetic material is heated. As a result, it is difficult to efficiently convert low-temperature exhaust heat energy or sunlight heat energy into mechanical energy or the like.

The following Patent documents 1-5 and Non-patent document 1 are hereunder presented as prior art documents relating to energy converters, such as this type of conventional thermomagnetic motor.

In Patent document 1 there is disclosed an image-forming device comprising a heating roller with a magnetic shunt alloy drum, and a permanent magnet that generates rotational torque by distribution of the flux density of the heating roller. In this image-forming device, however, heating a portion of the heating roller with the magnetic shunt alloy drum results in considerable heat loss by the flow of heat from the high temperature section to the low temperature section of the heating roller.

Patent document 2 discloses a hybrid electric power generator with an optical-thermomagnetic power generator comprising a lens that collects solar heat, photoconducting fiber that guides a heat source from solar heat that has been collected by the lens to a prescribed location, an optical-thermomagnetic motor-type magnetic turntable that is rotated by the heat source from the photoconducting fiber and has situated thereon chips composed of a plurality of temperature-sensitive magnetic substances (low-temperature Curie point magnetic substances), and flux-generating means provided integrally with the magnetic turntable, and also with a wind power generator comprising a disc wheel that rotates under the influence of wind power, a rotating shaft that rotates by rotation of the disc wheel, an outer cylinder provided integrally with the rotating shaft, and an armature coil provided on the inside perimeter of the outer cylinder and opposite the flux-generating means. In this hybrid electric power generator, however, heating some of the chips composed of a plurality of temperature-sensitive magnetic substances arranged on the optical-thermomagnetic motor-type magnetic turntable produces a flow of heat from the high temperature section to the low temperature section of each individual chip, resulting in considerable heat loss. In addition, since the magnet is situated on one side of the temperature-sensitive magnetic chip, it is not possible to generate strong rotational torque without application of a powerful magnetic field on the chip.

Patent Document 3 discloses an optical-thermomagnetic drive unit comprising a support made of a non-magnetic material supported in a freely rotatable manner, a plurality of temperature-sensitive magnetic materials (low-temperature Curie point magnetic substances) made of a Ni group alloy having a low-temperature Curie point, arranged on the support at a prescribed spacing in the direction of rotation of the support, a magnetic field-generating magnet situated opposite one or a plurality of the temperature-sensitive magnetic materials, and a heat collector that collects heat as a spot from a photothermal source at a location shifted from the magnetized center of the temperature-sensitive magnetic material positioned opposite the magnet. In this optical-thermomagnetic drive unit, however, heating some of the plurality of temperature-sensitive magnetic materials arranged on the support increases the heat loss by flow of heat from the high temperature section to the low temperature section of each individual temperature-sensitive magnetic material. In addition, since a powerful magnetic field is not applied across a sufficiently wide region of the temperature-sensitive magnetic substance, it is not possible to generate strong rotational torque.

Patent document 4 discloses a method in which, with a thermomagnetic rotation device comprising a heat-sensitive magnetic cylinder pivoting in a freely rotatable manner, a magnet having its magnetic poles positioned in the circumferential direction of the cylinder and being oriented opposite the peripheral surface of the cylinder, a heating region which heats a section of the cylinder, and a cooling region that cools the other sections of the cylinder, a portion of the cylinder is heated by high-temperature cooling water flowing out of an engine and part of the thermal energy of the high-temperature cooling water is converted to mechanical energy by the thermomagnetic rotation device. In this thermomagnetic rotation device, however, heating a section of the heat-sensitive magnetic cylinder increases the heat loss by flow of heat from the high temperature section to the low temperature section of the cylinder.

Patent document 5 discloses a thermal motor employing a heat-sensitive magnetic substance, comprising a U-phase field unit composed of a first field magnet (permanent magnet), a first heat-sensitive magnetic substance (first low temperature Curie point magnetic substance) and a first field pole (yoke), and a separate V-phase field unit composed of a second field magnet, a second heat-sensitive magnetic substance (second low temperature Curie point magnetic substance) and a second field pole, and having a phase contrast of 90 degrees with respect to the U-phase field unit, the first field magnet, wherein the first heat-sensitive magnetic substance, the first field pole, the second field magnet, the second heat-sensitive magnetic substance and the second field pole are magnetically connected in series to form a magnetic circuit, the first heat-sensitive magnetic substance is cooled while the second heat-sensitive magnetic substance is heated, and the cooling and heating are switched to induce rotary driving of the rotor magnet.

With the thermal motor disclosed in Patent document 5, however, the first and second field magnets are magnetized in the direction parallel to the rotating shaft of the thermal motor, unlike the composite magnetic ring of the present invention described hereunder, and the soft magnetic materials of a pair of yokes (field poles) are purposely used to form a magnetic circuit in the direction parallel to the rotating shaft. When the heat-sensitive magnetic substance is heated in this thermal motor, therefore, heat loss is significant due to flow of heat from the high temperature section of the heat-sensitive magnetic substance to the low temperature sections of the other components such as the yoke.

Furthermore, in the thermal motor disclosed in Patent document 5, as shown in its accompanying drawings FIG. 3 and FIG. 4, the yoke 4U bends inward from the edge of the heat-sensitive magnetic substance 1U, being extended along the permanent magnet 3U in the direction of the S-pole of the permanent magnet 3U. Consequently, a portion of the yoke 4U is near the N-pole of the permanent magnet 3U, and when the heat-sensitive magnetic substance 1U increases in temperature and the magnetic permeability falls, the flux leaving the N-pole of the permanent magnet 3U collects at the section of part of the yoke 4U that is near the N-pole of the permanent magnet 3U. As a result, the amount of flux that passes through the yoke 4U and generates a magnetic field inside the field unit is not significantly changed even when the temperature of the heat-sensitive magnetic substance 1U varies, and it is therefore difficult to create a powerful rotating magnetic field.

According to FIG. 4 showing the thermal motor disclosed in Patent document 5, the N-pole of a permanent magnet |3U and the S-pole of a permanent magnet 3U are linked by a yoke |4U, while the N-pole of the permanent magnet 3U and the S-pole of the permanent magnet |3U are linked by a yoke 4U through a heat-sensitive magnetic substance 1U and a heat-sensitive magnetic substance |1U. Consequently, most of the flux circulates along this loop in the counter-clockwise direction of the cross-sectional view of FIG. 4, making it difficult to create a powerful rotating magnetic field at the location where the rotor enters. Also, according to FIG. 4, flux that has exited the 2 permanent magnets passes through the gap between the yoke 4U and the yoke |4U and most of each is circulated without significant leakage to the location where the rotor enters, and it is therefore difficult to generate a sufficiently large rotary force by a powerful rotating magnetic field.

In Non-patent document 1, as already explained, a thermomagnetic engine comprising a rotor with a disc-shaped soft magnetic material composed of a low-temperature Curie point magnetic substance such as a magnetic shunt alloy, and a stator provided with a permanent magnet for application of an external magnetic field, wherein a portion of the disc-shaped soft magnetic material is sandwiched between the magnetic poles of the permanent magnet of the stator, and a portion of the disc-shaped soft magnetic material in the region with a large magnetic field gradient is heated is disclosed. In this thermomagnetic engine, as already explained, significant heat loss takes place during heating of the disc-shaped soft magnetic material, due to flow of heat from the low temperature section to the high temperature section of the disc-shaped soft magnetic material.

Thus, the same problems of conventional thermomagnetic motors are encountered in Patent documents 1 to 5 and in Non-patent document 1.

### PRIOR ART DOCUMENTS

### Patent Literature

Patent document 1 Japanese Unexamined Patent Publication No. 2008-129310

Patent document 2 Japanese Unexamined Patent Publication No. 2005-76565

Patent document 3 Japanese Unexamined Patent Publication No. 2002-204588

Patent document 4 Japanese Unexamined Patent Publication No. 2001-289045

Patent document 5 Japanese Unexamined Patent Publication HEI No. 6-351222

### Non-Patent Literature

Non-patent Document 1 Nishikawa, M. (Osaka University) and Yoshikawa, K. (Fujikin, Inc.), “Development of thermomagnetic engines for recovery and utilization of exhaust heat energy (Design and manufacturing of 100 W grade thermomagnetic engines)” (2000 New Energy and Industrial Technology Development Organization, Creative Proposal Candidates for New Industries, Research Report (Final), March, 2001, Osaka University (Energy/Environmental Technology 98E, 05-001)

### SUMMARY OF THE INVENTION

### Problems to be Solved by the Invention

The present invention has been accomplished in light of the problems mentioned above, and its object is to provide a composite magnetic ring that can be used for effective utilization of exhaust heat energy or sunlight heat energy as mechanical energy or electrical energy, at low cost, while minimizing heat loss due to flow of heat from the high temperature sections to the low temperature sections, as well as an energy converter for effective conversion of low-temperature exhaust heat energy or sunlight heat energy to mechanical energy or electrical energy, while minimizing heat loss due to flow of heat from the high temperature sections to the low temperature sections of the low-temperature Curie point magnetic substances in the composite magnetic ring.

### Means for Solving the Problems

In order to solve the problems mentioned above, the composite magnetic ring according to one mode of the invention has a construction wherein a plurality of permanent magnets are arranged in a ring shape at a prescribed spacing, and low-temperature Curie point magnetic substances having a Curie point at low temperature are sandwiched between each 2 adjacent permanent magnets, so that the plurality of permanent magnets and the plurality of low-temperature Curie point magnetic substances are situated in an alternating arrangement forming a ring.

In the composite magnetic ring of this mode of the invention, preferably a heat-insulating material is sandwiched between each permanent magnet and the low-temperature Curie point magnetic substance adjacent to that permanent magnet.

Also preferably, in the composite magnetic ring of this mode of the invention, at least one of the low-temperature Curie point magnetic substances is heated at a temperature near the Curie point of the low-temperature Curie point magnetic substance, and the magnetic permeability of the low-temperature Curie point magnetic substance is altered, thereby generating a magnetic field in the vicinity of the low-temperature Curie point magnetic substance.

Also preferably, in the composite magnetic ring of this mode of the invention, the low-temperature Curie point magnetic substance to be heated is switched in consecutive order for heating while the low-temperature Curie point magnetic substances other than the one to be heated are switched in consecutive order for cooling, thereby generating a rotating magnetic field inside the composite magnetic ring.

The energy converter of this mode of the invention has a construction comprising a composite magnetic ring in which a plurality of permanent magnets are arranged in a ring shape at a prescribed spacing, and low-temperature Curie point magnetic substances having a Curie point at low temperature (for example, near room temperature) are sandwiched between each 2 adjacent permanent magnets, so that the plurality of permanent magnets and the plurality of low-temperature Curie point magnetic substances are situated in an alternating arrangement forming a ring, and a rotor situated inside the composite magnetic ring and having a plurality of magnetic poles, wherein at least one low-temperature Curie point magnetic substance in the composite magnetic ring is heated to a temperature near the Curie point of the low-temperature Curie point magnetic substance, and the magnetic permeability of the low-temperature Curie point magnetic substance is altered, thereby generating a magnetic field in the vicinity of the low-temperature Curie point magnetic substance, to cause rotation of the rotor.

Preferably, the energy converter of this mode of the invention is constructed so that a heat-insulating material is sandwiched between each permanent magnet and the low-temperature Curie point magnetic substance adjacent to that permanent magnet.

Also preferably, this construction in the energy converter of this mode of the invention is such that the low-temperature Curie point magnetic substance to be heated is switched in consecutive order for heating in cooperation with the rotor, while the low-temperature Curie point magnetic substances other than the one to be heated are switched in consecutive order for cooling, so that the rotor rotates in a continuous manner.

The energy converter according to another mode of the invention has a construction comprising a composite magnetic ring in which a plurality of permanent magnets are arranged in a ring shape at a prescribed spacing, and low-temperature Curie point magnetic substances having a Curie point at low temperature are sandwiched between each 2 adjacent permanent magnets, so that the plurality of permanent magnets and the plurality of low-temperature Curie point magnetic substances are situated in an alternating arrangement forming a ring, a rotor situated inside the composite magnetic ring and having a plurality of magnetic poles, and heating means that heats at least one low-temperature Curie point magnetic substance in the composite magnetic ring, wherein at least one low-temperature Curie point magnetic substance in the composite magnetic ring is heated to a temperature near the Curie point of the low-temperature Curie point magnetic substance by the heating means, and the magnetic permeability of the low-temperature Curie point magnetic substance is altered, thereby generating a magnetic field in the vicinity of the low-temperature Curie point magnetic substance, to cause rotation of the rotor.

Preferably, the energy converter of this other mode of the invention is constructed so that a heat-insulating material is sandwiched between each permanent magnet and the low-temperature Curie point magnetic substance adjacent to that permanent magnet.

Also preferably, this construction in the energy converter of the other mode of the invention is such that the low-temperature Curie point magnetic substance to be heated is switched in consecutive order for heating in cooperation with the rotor, while the low-temperature Curie point magnetic substances other than the one to be heated are switched in consecutive order for cooling, so that the rotor rotates in a continuous manner.

### Effect of the Invention

In summary, since a plurality of low-temperature Curie point magnetic substances and a plurality of permanent magnets are placed in an alternating arrangement forming a ring, it is possible according to the invention to evenly heat only the low-temperature Curie point magnetic substance that is to be heated, while it is separated from the other low-temperature Curie point magnetic substances. Consequently, heat loss due to flow of heat from the high temperature section of the low-temperature Curie point magnetic substance to the low temperature sections of the other low-temperature Curie point magnetic substances is notably reduced, and efficiency for heating the low-temperature Curie point magnetic substances is increased. In this case, even with a very slight temperature difference between the high temperature section and the low temperature section of the low-temperature Curie point magnetic substance, the rotor can be rotated by appropriately setting the temperature of the Curie point of the low-temperature Curie point magnetic substance according to this temperature difference. As a result, it is possible to convert low-temperature exhaust heat energy and sunlight heat energy to mechanical energy or electrical energy at low cost and in an efficient manner.

Furthermore, according to the invention, the construction is such that a heat-insulating material is sandwiched between each permanent magnet in the composite magnetic ring and the low-temperature Curie point magnetic substance adjacent to each permanent magnet, so that the low-temperature Curie point magnetic substance is isolated from the permanent magnet by the heat-insulating material. This eliminates heat flow from the high temperature section of the low-temperature Curie point magnetic substance which is to be heated, and the low temperature sections of the other low-temperature Curie point magnetic substances, thereby minimizing heat loss.

### BRIEF DESCRIPTION OF THE DRAWINGS

FIG. 1 is a plan view showing the overall construction of a common thermomagnetic motor presented as a comparison with the present invention.

FIG. 2 is a plan view showing the overall construction of a composite magnetic ring according to the invention.

FIG. 3 is a plan view illustrating a method of heating the composite magnetic ring of FIG. 2.

FIG. 4 is a plan view showing the operating principle of a thermomagnetic motor employing the composite magnetic ring of FIG. 2.

FIG. 5 is a perspective view showing the overall construction of an example of a thermomagnetic motor according to the invention.

FIG. 6 is a perspective view showing the positional relationship between the low-temperature Curie point magnetic substance and the absorber plate in the example of FIG. 5.

FIG. 7 is a front view showing the relationship between the sunlight collecting pathway and the mirror in the example of FIG. 5.

FIG. 8 is a plan view showing the state of a rotating rotor in the example of FIG. 5.

FIG. 9 is a plan view showing the overall construction of a modification of the example of FIG. 5.

FIG. 10 is a diagram showing the operating principle of a modified example of the thermomagnetic motor of FIG. 4.

### BEST MODE FOR CARRYING OUT THE INVENTION

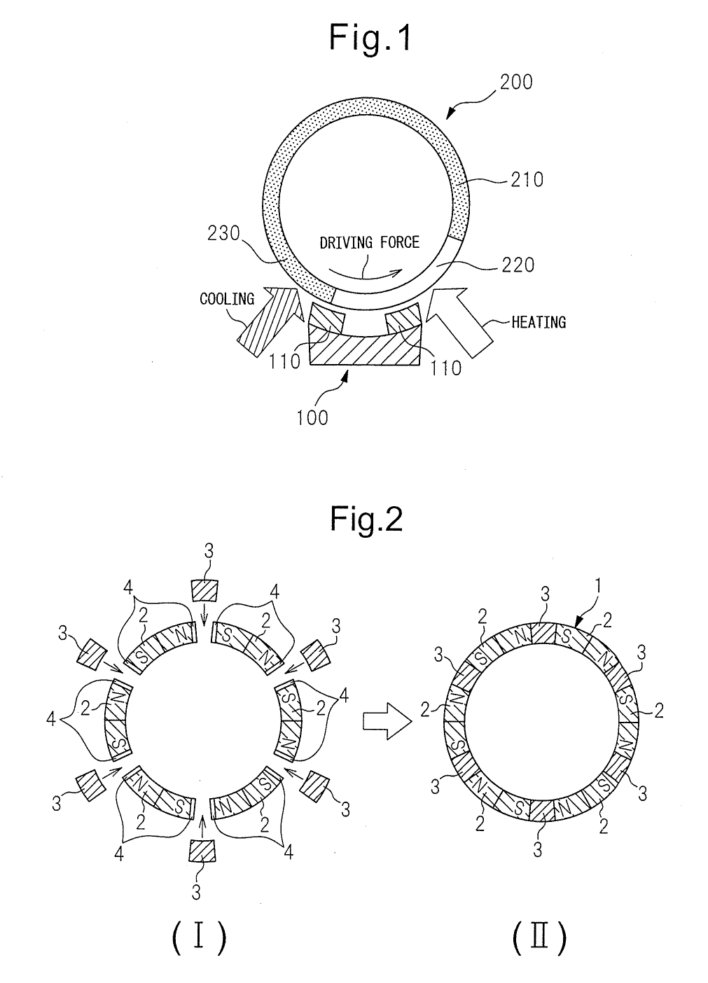

First, before explaining the construction and operation of examples of a composite magnetic ring and energy converter of the invention, the construction and problems inherent in a common thermomagnetic motor, presented for comparison with the invention, will be explained with reference to the accompanying drawings (FIG. 1).

FIG. 1 is a plan view showing the overall construction of a common thermomagnetic motor presented as a comparison with the present invention. The thermomagnetic motor shown in FIG. 1 essentially corresponds to the thermomagnetic engine disclosed in Non-patent document 1 mentioned above.

The common thermomagnetic motor shown in FIG. 1 is provided with a rotor 200 having a disc-shaped soft magnetic material 210 composed of a low-temperature Curie point magnetic substance such as a magnetic shunt alloy (for example, Ni—Fe (nickel-iron) alloy), and a stator 100 comprising permanent magnets 110 that apply an external magnetic field. When a certain region of the disc-shaped soft magnetic material 210 composing the principal part of the rotor 200 is heated to form a high temperature section 220 while the other regions of the disc-shaped soft magnetic material 210 are cooled to form low temperature sections 230, a temperature difference is produced in the disc-shaped soft magnetic material. Generally, a disc-shaped soft magnetic material 210 such as a magnetic shunt alloy, in its regions of lower temperature than the Curie point, has drastically lower magnetic permeability as the temperature approaches the Curie point, in the range near the Curie point. Consequently, the magnetic permeability at the high temperature section of the disc-shaped soft magnetic material 210 is a much lower value than the magnetic permeability at the low temperature section. When an external magnetic field is applied roughly perpendicular to the interface between the high temperature section and the low temperature section of the disc-shaped soft magnetic material 100, by the permanent magnets 110 of the stator 100, a force is generated which attracts the low temperature section 230 of the disc-shaped soft magnetic material 210, which has high magnetic permeability, in the direction of the high temperature section 220 of the disc-shaped soft magnetic material 210, which has low magnetic permeability. As a result, rotary force (driving force) is generated to rotate the rotor 200 in the direction from the low temperature section 230 to the high temperature section 220 of the disc-shaped soft magnetic material 210, and the rotor rotates in the counter-clockwise direction according to this rotary force.

In a common thermomagnetic motor such as shown in FIG. 1, a portion of the disc-shaped soft magnetic material 210 is sandwiched between the magnetic poles of the permanent magnets 110 of the stator 100, and the portion of the disc-shaped soft magnetic material 210 in the region with a large magnetic field gradient becomes heated. Heat therefore flows from the high temperature section 220 to the low temperature section 230 of the disc-shaped soft magnetic material 210, thus inhibiting adequate heating of the disc-shaped soft magnetic material 210 (first undesirable situation).

Also, since the size of the disc-shaped soft magnetic material 210 is limited in the structure of the common thermomagnetic motor shown in FIG. 1, it is not possible to obtain very large spacing between the high temperature section 220 and the low temperature section 230 of the disc-shaped soft magnetic material 210. In addition, in order to obtain a large rotary force it is necessary to increase some degree of the temperature gradient at the boundary between the high temperature section 220 and the low temperature section 230 of the disc-shaped soft magnetic material 210, in order to increase the difference in the magnetic permeability between the high temperature section 220 and low temperature section 230 of the disc-shaped soft magnetic material 210. Typically, the high temperature section 220 of the disc-shaped soft magnetic material 210 is set to about 100° C. and the low temperature section 230 is set to about 60° C., for a temperature difference of about 40° C. The heat loss is therefore increased due to the flow of heat when the disc-shaped soft magnetic material is heated. As a result, it is difficult to efficiently convert low-temperature exhaust heat energy or sunlight heat energy into mechanical energy or the like (second undesirable situation).

The construction and operation of examples of a composite magnetic ring and energy converter of the invention, designed to deal with the aforementioned first and second undesirable situations, will now be explained with reference to the accompanying drawings (FIG. 2 to FIG. 10).

FIG. 2 is a plan view showing the overall construction of a composite magnetic ring according to the invention. This simplified view shows the construction of the composite magnetic ring 1 of the example of the invention, which is to be applied to an energy converter (for example, a thermomagnetic motor) for conversion of low-temperature exhaust heat energy or sunlight heat energy to mechanical energy or electrical energy. Components identical to those mentioned above will hereunder be denoted by like reference numerals.

When a composite magnetic ring 1 according to the example of the invention is fabricated, a plurality of permanent magnets 2 are arranged in a ring shape at a prescribed spacing, as shown in FIG. 2(I), and low-temperature Curie point magnetic substances 3 having relatively low Curie points (for example, near room temperature) are sandwiched between every 2 adjacent permanent magnets. This produces a structure in which the composite magnetic ring 1 has a plurality of permanent magnets 2 and a plurality of low-temperature Curie point magnetic substances 3 placed in an alternating arrangement forming a ring, as shown in FIG. 2(II). The composite magnetic ring 1 has 6 low-temperature Curie point magnetic substances, but the composite magnetic ring may be formed with any other desired number of low-temperature Curie point magnetic substances. When the composite magnetic ring 1 is actually fabricated, preferably the plurality of permanent magnets 2 are arranged in a ring shape with their S-poles and N-poles facing at the prescribed spacing, and the low-temperature Curie point magnetic substances 3 are sandwiched between every two adjacent permanent magnets.

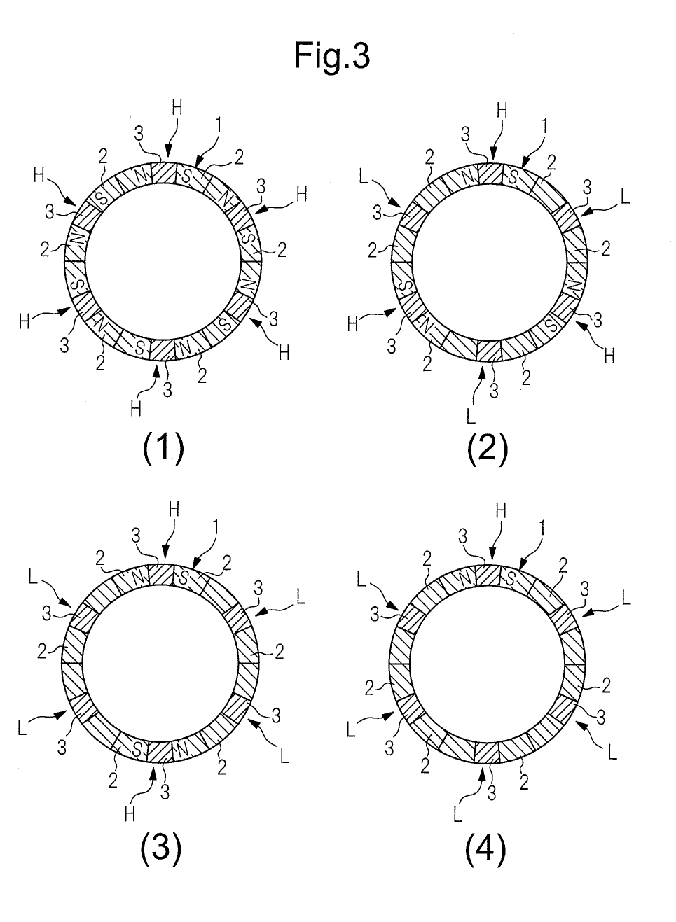

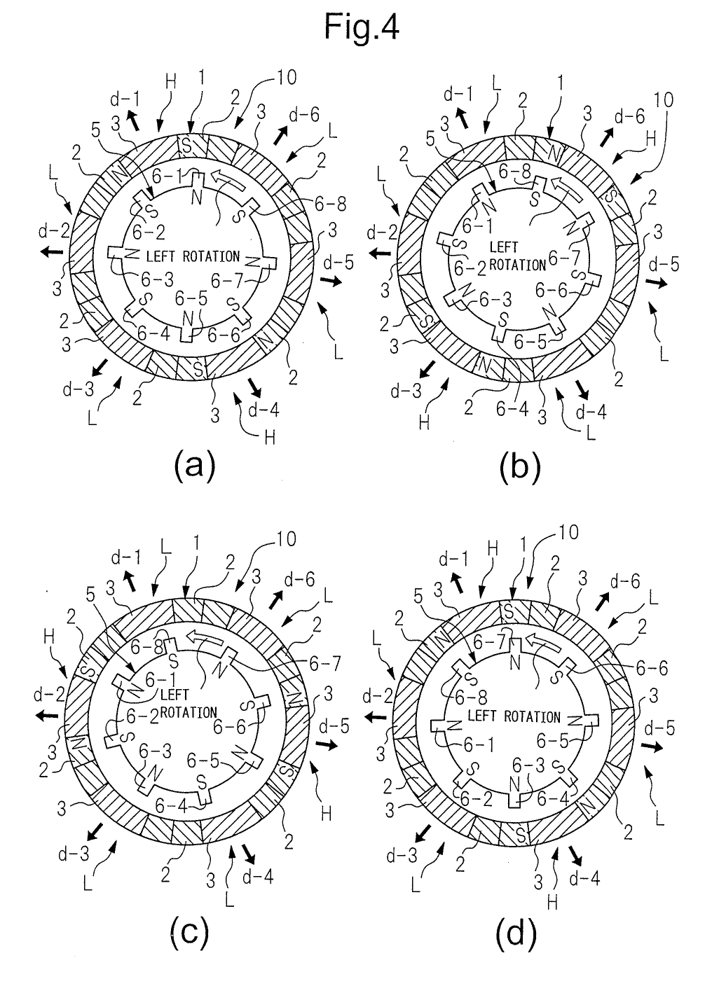

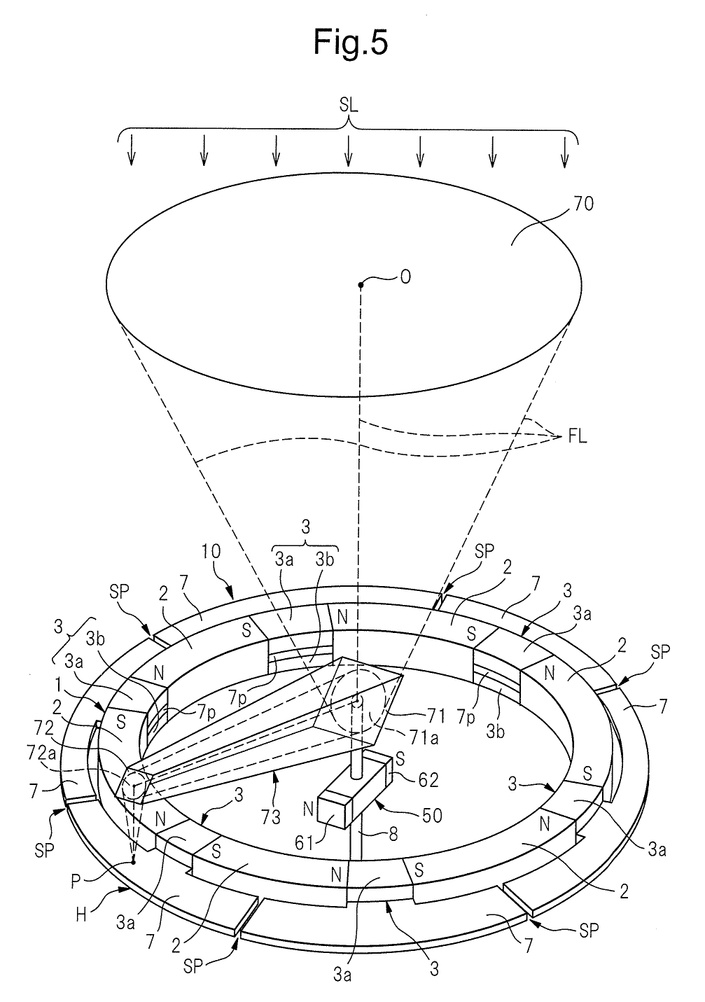

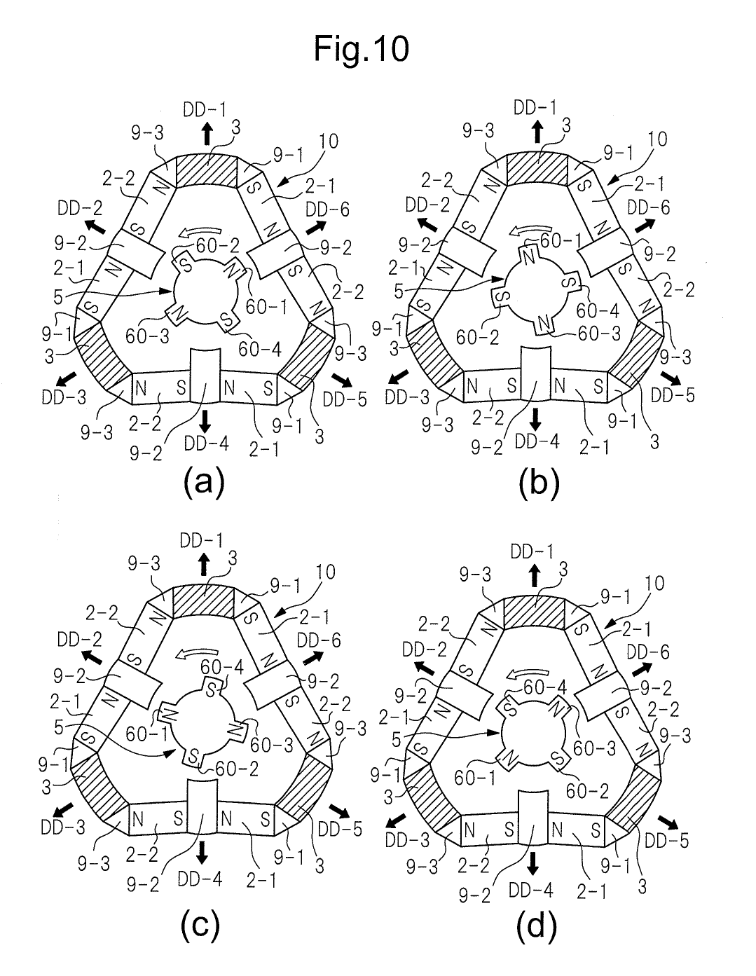

Also, heat-insulating materials 4 such as heat-insulating sheets are sandwiched between each permanent magnet 2 and the low-temperature Curie point magnetic substances 3 adjacent to the permanent magnet 2, as shown in FIG. 2(I). The heat-insulating materials 4 are situated to prevent direct contact between either edge of the plurality of permanent magnets 2 (the N-pole or S-pole section) and either edge of the plurality of low-temperature Curie point magnetic substances 3, and they can prevent flow of heat from the high temperature sections to the low temperature sections of the low-temperature Curie point magnetic substances 3 (a heat-insulating effect is obtained by the heat-insulating materials 4). In FIG. 2(II) and in FIG. 3, FIG. 4, FIG. 5 and FIG. 10 explained hereunder, the heat-insulating materials 4 are omitted to simplify explanation of the structure of the composite magnetic ring 1.

An inexpensive barium ferrite magnet is preferably used for the permanent magnets 2. Also, inexpensive manganese-zinc ferrite (for example, manganese-zinc ferrite having the composition Mn_{0.25}Zn_{0.75}Fe₂O₄) is used for the low-temperature Curie point magnetic substances 3. Here, the temperature of the Curie point of the low-temperature Curie point magnetic substances is pre-set to be near room temperature (25° C.) (for example, 30° C.-60° C.), but in most cases it may vary from about −40° C. to 100° C., depending on the composition. The heat-insulating materials 4 used are heat-insulating sheets composed of Teflon® sheets, for example.

As an alternative construction, narrow gaps may be provided at both ends of each low-temperature Curie point magnetic substance, instead of sandwiching heat-insulating materials between each permanent magnet and the low-temperature Curie point magnetic substances adjacent to the permanent magnet. This type of construction also prevents direct contact between either edge of the plurality of permanent magnets and either edge of the plurality of low-temperature Curie point magnetic substances, similar to the composite magnetic ring of FIG. 1, and therefore flow of heat from the high temperature section to the low temperature section of the low-temperature Curie point magnetic substance can be prevented.

FIG. 3 is a plan view illustrating a method of heating the composite magnetic ring of FIG. 2, and FIG. 4 is a plan view illustrating the operating principle of a thermomagnetic motor employing the composite magnetic ring of FIG. 2. This assumes that in an energy converter such as a thermomagnetic motor, the composite magnetic ring 1 according to the example of the invention is used as a stator with 12 magnetic poles. However, a stator having any desired number of magnetic poles other than 12 may be used in a thermomagnetic motor or the like.

When the plurality of low-temperature Curie point magnetic substances 3 are all in a low temperature (L) (for example, room temperature (25° C.)) state without heating, the magnetic permeabilities of all of the low-temperature Curie point magnetic substances 3 remain as comparatively high values. In this state, the flux generated at the edge of each permanent magnet 2 (the N-pole or S-pole section) passes in a concentrated manner through the low-temperature Curie point magnetic substances 3 situated adjacent to each permanent magnet 2, with virtually no leakage outside of the low-temperature Curie point magnetic substances 3. Consequently, no magnetic field is generated outside of the low-temperature Curie point magnetic substances 3.

As shown in FIG. 3(1), when all of the low-temperature Curie point magnetic substances 3 are heated to a high temperature (H) (for example, 40° C.), creating a state of increase to a temperature near the Curie point of the low-temperature Curie point magnetic substances 3, the magnetic permeabilities of all of the low-temperature Curie point magnetic substances 3 are altered to relatively low values. In this state, the flux generated at the edge of each permanent magnet 2 (the N-pole or S-pole section) not only passes through the low-temperature Curie point magnetic substances 3 situated adjacent to each permanent magnet 2, but also leaks to the exterior regions near the low-temperature Curie point magnetic substances 3. However, since a magnetic field is similarly generated near all of the low-temperature Curie point magnetic substances 3, it is not possible to generate a rotating magnetic field. Since a rotating magnetic field cannot be generated on the inner side of the composite magnetic ring 1, it is not possible to rotate the rotor situated inside the composite magnetic ring 1.

However, if the plurality of low-temperature Curie point magnetic substances 3 are alternately heated (i.e., every other one of the 6 low-temperature Curie point magnetic substances 3 is heated), so that 3 of the low-temperature Curie point magnetic substances 3 are at high temperature (H), as shown in FIG. 3(2), creating a state of increase to a temperature near the Curie points of the low-temperature Curie point magnetic substances 3 that are heated, the magnetic permeabilities of the low-temperature Curie point magnetic substances 3 that are heated are altered to relatively low values. In contrast, the 3 non-heated low-temperature Curie point magnetic substances 3 naturally cool to near the low temperature (L), and the magnetic permeabilities of the non-heated low-temperature Curie point magnetic substances 3 remain relatively high values. In this state, the flux generated at the edges of the permanent magnets 2 situated adjacent to the 3 low-temperature Curie point magnetic substances 3 that are heated not only passes through the interior of the low-temperature Curie point magnetic substances 3 that are heated, but also leaks outside near the low-temperature Curie point magnetic substances 3. During this time, a magnetic field is generated only near the 3 low-temperature Curie point magnetic substances 3 that are heated, allowing a rotating magnetic field to be generated on the inner side of the composite magnetic ring 1, and therefore the rotor situated inside the composite magnetic ring 1 can be rotated.

Also, when two low-temperature Curie point magnetic substances 3 are symmetrically heated through the center of the composite magnetic ring 1 to a high temperature (H), as shown in FIG. 3(3), creating a state of increase to a temperature near the Curie points of the low-temperature Curie point magnetic substances 3 that are heated, the magnetic permeabilities of the low-temperature Curie point magnetic substances 3 that are heated are altered to relatively low values. In contrast, the 4 non-heated low-temperature Curie point magnetic substances 3 naturally cool near the low temperature (L), and the magnetic permeabilities of the non-heated low-temperature Curie point magnetic substances 3 remain relatively high values. In this state, the flux generated at the edges of the permanent magnets 2 situated adjacent to the two low-temperature Curie point magnetic substances 3 that are heated leaks outside near the low-temperature Curie point magnetic substances 3 that are heated. During this time, a magnetic field is generated only near the two low-temperature Curie point magnetic substances 3 that are heated, allowing a rotating magnetic field to be generated on the inner side of the composite magnetic ring 1, and therefore the rotor situated inside the composite magnetic ring 1 can be rotated, as in the case illustrated in FIG. 3(2).

Also, when only one low-temperature Curie point magnetic substance 3 is heated to a high temperature (H), as shown in FIG. 3(4), creating a state of increase to a temperature near the Curie points of the low-temperature Curie point magnetic substance 3 to be heated, the magnetic permeability of the low-temperature Curie point magnetic substance 3 to be heated is altered to a relatively low value. In contrast, the 5 non-heated low-temperature Curie point magnetic substances 3 naturally cool near the low temperature (L), and the magnetic permeabilities of the non-heated low-temperature Curie point magnetic substances 3 remain relatively high values. In this state, the flux generated at the edges of the permanent magnets 2 situated adjacent to the one low-temperature Curie point magnetic substance 3 that is heated leaks outside near the low-temperature Curie point magnetic substance 3 to be heated. During this time, a magnetic field is generated only near the one low-temperature Curie point magnetic substance 3 that is heated, allowing a rotating magnetic field to be generated on the inner side of the composite magnetic ring 1, and therefore the rotor situated inside the composite magnetic ring 1 can be rotated, as in the case illustrated in FIGS. 3(2) and (3).

In the method of heating the composite magnetic ring illustrated in FIG. 3(2)-(4), the low-temperature Curie point magnetic substances that are heated are naturally cooled to near a low temperature (for example, room temperature) after they have been heated, but a fluid such as cooling water may also be used for forcible cooling of the heated low-temperature Curie point magnetic substances to room temperature or to a lower temperature. This will allow a relatively large difference to be produced between the magnetic permeability of the low-temperature Curie point magnetic substances at high temperature and the magnetic permeability of the low-temperature Curie point magnetic substances at low temperature, so that a more powerful rotating magnetic field can be generated on the inner side of the composite magnetic ring, compared to the cases shown in FIG. 3(2)-(4).

The operating principle for rotational operation of a thermomagnetic motor according to, for example, the heating method shown in FIG. 3(3) (that is, a method of heating 2 low-temperature Curie point magnetic substances symmetrically through the center of the composite magnetic ring 1) will now be explained with reference to the operating principle illustrated in FIG. 4(a)-(d).

The thermomagnetic motor illustrated in FIG. 4(a)-(d) comprises a stator 10 having 12 magnetic poles composed of a composite magnetic ring 1 in which 6 permanent magnets 2 and 6 low-temperature Curie point magnetic substances 3, of the type shown in FIG. 2(II), are arranged in an alternating fashion, and a rotor 5 situated inside the composite magnetic ring 1. The rotor 5 has 8 magnetic poles 6-1 to 6-8, but a rotor having any other desired number of magnetic poles may be situated inside the stator. However, in order to allow activation of the rotor (starting of rotation of the rotor from a resting state) regardless of the positions of the magnetic poles of the rotor, the number of magnetic poles of the rotor is preferably not a multiple of 3 when the number of permanent magnets and the number of low-temperature Curie point magnetic substances of the stator are multiples of 3. Conversely, when the number of magnetic poles of the rotor is a multiple of 3, the number of permanent magnets and the number of low-temperature Curie point magnetic substances of the stator are preferably not multiples of 3.

At the start, it is assumed that the rotor 5 is positioned as shown in FIG. 4(a). The position of the center of the low-temperature Curie point magnetic substance 3 in the d-1 direction and the position intermediate between the magnetic pole 6-1 of the N-pole and the magnetic pole 6-2 of the S-pole of the rotor 5 are slightly misaligned. Similarly, the position of the center of the low-temperature Curie point magnetic substance 3 in the d-4 direction and the position intermediate between the magnetic pole 6-5 of the N-pole and the magnetic pole 6-6 of the S-pole of the rotor 5 are slightly misaligned. The low-temperature Curie point magnetic substance 3 in the d-1 direction and the low-temperature Curie point magnetic substance 3 in the d-4 direction are located symmetrically across the center of the composite magnetic ring 1.

As shown in FIG. 4(a), the low-temperature Curie point magnetic substance 3 in the d-1 direction and the low-temperature Curie point magnetic substance 3 in the d-4 direction that are located symmetrically across the center of the composite magnetic ring 1 are simultaneously heated to a high temperature (H), so that the two low-temperature Curie point magnetic substances 3 in the d-1 direction and the d-4 direction are increased in temperature to near their Curie points. In this state, the magnetic permeabilities of the two low-temperature Curie point magnetic substances 3 in the d-1 direction and the d-4 direction are altered to relatively low values. At this time, S-pole and N-pole magnetic poles are generated at both ends of the low-temperature Curie point magnetic substance 3 in the d-1 direction, and a magnetic field is formed near the low-temperature Curie point magnetic substance 3 in the d-1 direction. In this case, rotational torque is generated on the rotor 5, so that the orientation of the magnetic field formed by the S-pole and N-pole magnetic poles at both ends of the low-temperature Curie point magnetic substance 3 in the d-1 direction and the orientation of the magnetic field formed by the two magnetic poles 6-1,6-2 of the rotor 5, are approximately parallel, and in opposite directions (i.e., magnetostatic energy is minimized). At the same time, rotational torque is generated on the rotor 5, as with the two magnetic poles 6-1,6-2 described above, so that the orientation of the magnetic field formed by the S-pole and N-pole magnetic poles at both ends of the low-temperature Curie point magnetic substance 3 in the d-4 direction and the orientation of the magnetic field formed by the two magnetic poles 6-5,6-6 of the rotor 5, are approximately parallel, and in opposite directions.

In FIG. 4(a), this rotational torque causes slight rotation of the rotor 5 in the counter-clockwise direction, so that the position of the center of the low-temperature Curie point magnetic substance 3 in the d-1 direction and the position intermediate between the magnetic pole 6-1 of the N-pole and the magnetic pole 6-2 of the S-pole of the rotor 5 are positioned in the same direction as seen from the position at the center of the composite magnetic ring 1 (i.e., magnetostatic energy is minimized). Similarly, the rotor 5 rotates in the counter-clockwise direction by the same angle as with the two magnetic poles 6-1,6-2, so that the position of the center of the low-temperature Curie point magnetic substance 3 in the d-4 direction and the position intermediate between the magnetic pole 6-5 of the N-pole and the magnetic pole 6-6 of the S-pole of the rotor 5 are positioned in the same direction as seen from the position at the center of the composite magnetic ring 1. If the heated low-temperature Curie point magnetic substance 3 is not switched, the rotor 5 rotates slightly in the counter-clockwise direction, and comes to a stop.

Next, as shown in FIG. 4(b), two low-temperature Curie point magnetic substances 3 located symmetrical to each other, which were not heated in FIG. 4(a), are switched as the target of the current heating. The low-temperature Curie point magnetic substance 3 in the d-3 direction and the low-temperature Curie point magnetic substance 3 in the d-6 direction that are located symmetrically across the center of the composite magnetic ring 1 are simultaneously heated to a high temperature (H), so that the two low-temperature Curie point magnetic substances 3 in the d-3 direction and the d-6 direction are increased in temperature to near their Curie points. In this state, the magnetic permeabilities of the two low-temperature Curie point magnetic substances 3 in the d-3 direction and the d-6 direction are altered to relatively low values. At this time, S-pole and N-pole magnetic poles are generated at both ends of the low-temperature Curie point magnetic substance 3 in the d-3 direction, and a magnetic field is formed near the low-temperature Curie point magnetic substance 3 in the d-3 direction. In this case, rotational torque is generated on the rotor 5, so that the orientation of the magnetic field formed by the S-pole and N-pole magnetic poles at both ends of the low-temperature Curie point magnetic substance 3 in the d-3 direction and the orientation of the magnetic field formed by the two magnetic poles 6-3,6-4 of the rotor 5, are approximately parallel, and in opposite directions. At the same time, rotational torque is generated on the rotor 5, as with the two magnetic poles 6-3,6-4 described above, so that the orientation of the magnetic field formed by the S-pole and N-pole magnetic poles at both ends of the low-temperature Curie point magnetic substance 3 in the d-6 direction and the orientation of the magnetic field formed by the two magnetic poles 6-7,6-8 of the rotor 5, are approximately parallel, and in opposite directions.

In FIG. 4(b), this rotational torque causes rotation of the rotor 5 by a prescribed angle (for example, 30 degrees) in the counter-clockwise direction, so that the position of the center of the low-temperature Curie point magnetic substance 3 in the d-3 direction and the position intermediate between the magnetic pole 6-3 of the N-pole and the magnetic pole 6-4 of the S-pole of the rotor 5 are positioned in the same direction as seen from the position at the center of the composite magnetic ring 1. Similarly, the rotor 5 rotates in the counter-clockwise direction by the same angle as with the two magnetic poles 6-3,6-4, so that the position of the center of the low-temperature Curie point magnetic substance 3 in the d-6 direction and the position intermediate between the magnetic pole 6-7 of the N-pole and the magnetic pole 6-8 of the S-pole of the rotor 5 are positioned in the same direction as seen from the position at the center of the composite magnetic ring 1. However, the rotor 5 shown in FIG. 4(b) is shown in a state after having been rotated by the prescribed angle from the direction of FIG. 4(a), by rotational torque generated as a result of the temperature distribution of the composite magnetic ring 1 shown in FIG. 4(b).

At the same time, the two low-temperature Curie point magnetic substances 3 in the d-1 and d-4 directions, being unheated, fall in temperature and naturally cool to near the low temperature (L). In this state, the magnetic permeabilities of the two low-temperature Curie point magnetic substances 3 in the d-1 and d-4 directions are altered to relatively high values. Consequently, the magnetic poles generated at both ends of the low-temperature Curie point magnetic substances 3 are annihilated. This eliminates interaction between the two magnetic poles 6-1,6-2 of the rotor 5 and the magnetic field generated at both ends of the low-temperature Curie point magnetic substance 3 in the d-1 direction, while also eliminating interaction between the two magnetic poles 6-5,6-6 of the rotor 5 and the magnetic field generated at both ends of the low-temperature Curie point magnetic substance 3 in the d-4 direction, thus facilitating, for example, 30 degree rotation of the rotor 5 as mentioned above.

In FIG. 4(b), after the two low-temperature Curie point magnetic substances 3 in the d-1 and d-4 directions have been heated, they naturally cool to near the low temperature (L), but a fluid such as cooling water may be used for forcible cooling of the two heated low-temperature Curie point magnetic substances to room temperature or to a lower temperature. This will allow a relatively large difference to be produced between the magnetic permeability of the low-temperature Curie point magnetic substance at high temperature (H) and the magnetic permeability of the low-temperature Curie point magnetic substance at low temperature (L), so that a more powerful rotating magnetic field can be generated on the inner side of the composite magnetic ring, compared to the case shown in FIG. 4(b).

Furthermore, as shown in FIG. 4(c), two low-temperature Curie point magnetic substances 3 located symmetrical to each other, which were not heated in FIGS. 4(a) and (b), are switched as the target of the current heating. The low-temperature Curie point magnetic substance 3 in the d-2 direction and the low-temperature Curie point magnetic substance 3 in the d-5 direction that are located symmetrically across the center of the composite magnetic ring 1 are simultaneously heated to a high temperature (H), so that the two low-temperature Curie point magnetic substances 3 in the d-2 direction and the d-5 direction are increased in temperature to near their Curie points. In this state, the magnetic permeabilities of the two low-temperature Curie point magnetic substances 3 in the d-2 direction and the d-5 direction are altered to relatively low values. At this time, S-pole and N-pole magnetic poles are generated at both ends of the low-temperature Curie point magnetic substance 3 in the d-2 direction, and a magnetic field is formed near the low-temperature Curie point magnetic substance 3 in the d-5 direction. In this case, rotational torque is generated on the rotor 5, so that the orientation of the magnetic field formed by the S-pole and N-pole magnetic poles at both ends of the low-temperature Curie point magnetic substance 3 in the d-2 direction and the orientation of the magnetic field formed by the two magnetic poles 6-1,6-2 of the rotor 5, are approximately parallel, and in opposite directions. At the same time, rotational torque is generated on the rotor 5, as with the two magnetic poles 6-1,6-2 described above, so that the orientation of the magnetic field formed by the S-pole and N-pole magnetic poles at both ends of the low-temperature Curie point magnetic substance 3 in the d-5 direction and the orientation of the magnetic field formed by the two magnetic poles 6-5,6-6 of the rotor 5, are approximately parallel, and in opposite directions.

In FIG. 4(c), this rotational torque causes further rotation of the rotor 5 by, for example, 30 degrees in the counter-clockwise direction, so that the position of the center of the low-temperature Curie point magnetic substance 3 in the d-2 direction and the position intermediate between the magnetic pole 6-1 of the N-pole and the magnetic pole 6-2 of the S-pole of the rotor 5 are positioned in the same direction as seen from the position at the center of the composite magnetic ring 1. Similarly, the rotor 5 rotates in the counter-clockwise direction by the same angle as with the two magnetic poles 6-1,6-2, so that the position of the center of the low-temperature Curie point magnetic substance 3 in the d-5 direction and the position intermediate between the magnetic pole 6-5 of the N-pole and the magnetic pole 6-6 of the S-pole of the rotor 5 are positioned in the same direction as seen from the position at the center of the composite magnetic ring 1. However, the rotor 5 shown in FIG. 4(c) is shown in a state after having been rotated by the prescribed angle from the direction of FIG. 4(b), by rotational torque generated as a result of the temperature distribution of the composite magnetic ring 1 shown in FIG. 4(c).

At the same time, the two low-temperature Curie point magnetic substances 3 in the d-3 and d-6 directions, being unheated, fall in temperature and naturally cool to near the low temperature (L). In this state, the magnetic permeabilities of the two low-temperature Curie point magnetic substances 3 in the d-3 and d-6 directions are altered to relatively high values. Consequently, the magnetic poles generated on both sides of the low-temperature Curie point magnetic substance 3 are annihilated. This eliminates interaction between the two magnetic poles 6-3,6-4 of the rotor 5 and the magnetic field generated at both ends of the low-temperature Curie point magnetic substance 3 in the d-3 direction, while also eliminating interaction between the two magnetic poles 6-7,6-8 of the rotor 5 and the magnetic field generated at both ends of the low-temperature Curie point magnetic substance 3 in the d-6 direction, thus facilitating, for example, 30 degree rotation of the rotor 5 as mentioned above.

In FIG. 4(c), after the two low-temperature Curie point magnetic substances 3 in the d-3 and d-6 directions have been heated, they naturally cool to near the low temperature (L), but a fluid such as cooling water may be used for forcible cooling of the two heated low-temperature Curie point magnetic substances to room temperature or to a lower temperature. This will allow a relatively large difference to be produced between the magnetic permeability of the low-temperature Curie point magnetic substances at high temperature (H) and the magnetic permeability of the low-temperature Curie point magnetic substances at low temperature (L), so that a more powerful rotating magnetic field can be generated on the inner side of the composite magnetic ring, compared to the case shown in FIG. 4(c).

Furthermore, as shown in FIG. 4(d), two low-temperature Curie point magnetic substances 3 located symmetrical to each other, which were not heated in FIGS. 4(b) and (c) (the two low-temperature Curie point magnetic substances 3 located symmetrical to each other that have naturally cooled after being heated in FIG. 4(a)) are switched as the target of the current heating. The low-temperature Curie point magnetic substance 3 in the d-1 direction and the low-temperature Curie point magnetic substance 3 in the d-4 direction that are located symmetrically across the center of the composite magnetic ring 1 are simultaneously heated to a high temperature (H), so that the two low-temperature Curie point magnetic substances 3 in the d-1 direction and the d-4 direction are again increased in temperature to near their Curie points. In this state, the magnetic permeabilities of the two low-temperature Curie point magnetic substances 3 in the d-1 direction and the d-4 direction are altered to relatively low values. At this time, S-pole and N-pole magnetic poles are generated at both ends of the low-temperature Curie point magnetic substance 3 in the d-1 direction, and a magnetic field is formed near the low-temperature Curie point magnetic substance 3 in the d-4 direction. In this case, rotational torque is generated on the rotor 5, so that the orientation of the magnetic field formed by the S-pole and N-pole magnetic poles at both ends of the low-temperature Curie point magnetic substance 3 in the d-1 direction and the orientation of the magnetic field formed by the two magnetic poles 6-7,6-8 of the rotor 5, are approximately parallel, and in opposite directions. At the same time, rotational torque is generated on the rotor 5, as with the two magnetic poles 6-7,6-8 described above, so that the orientation of the magnetic field formed by the S-pole and N-pole magnetic poles at both ends of the low-temperature Curie point magnetic substance 3 in the d-4 direction and the orientation of the magnetic field formed by the two magnetic poles 6-3,6-4 of the rotor 5, are approximately parallel, and in opposite directions.

In FIG. 4(d), this rotational torque causes further rotation of the rotor 5 by, for example, 30 degrees in the counter-clockwise direction, so that the position of the center of the low-temperature Curie point magnetic substance 3 in the d-1 direction and the position intermediate between the magnetic pole 6-7 of the N-pole and the magnetic pole 6-8 of the S-pole of the rotor 5 are positioned in the same direction as seen from the position at the center of the composite magnetic ring 1. Similarly, the rotor 5 rotates in the counter-clockwise direction by the same angle as with the two magnetic poles 6-7,6-8, so that the position of the center of the low-temperature Curie point magnetic substance 3 in the d-4 direction and the position intermediate between the magnetic pole 6-3 of the N-pole and the magnetic pole 6-4 of the S-pole of the rotor 5 are positioned in the same direction as seen from the position at the center of the composite magnetic ring 1. However, the rotor 5 shown in FIG. 4(d) is shown in a state after having been rotated by the prescribed angle from the direction of FIG. 4(c), by rotational torque generated as a result of the temperature distribution of the composite magnetic ring 1 shown in FIG. 4(d).

At the same time, the two low-temperature Curie point magnetic substances 3 in the d-2 and d-5 directions, being unheated, fall in temperature and naturally cool to near the low temperature (L). In this state, the magnetic permeabilities of the two low-temperature Curie point magnetic substances 3 in the d-2 and d-5 directions are altered to relatively high values. Consequently, the magnetic poles generated on both sides of the low-temperature Curie point magnetic substances 3 are annihilated. This eliminates interaction between the two magnetic poles 6-1,6-2 of the rotor 5 and the magnetic field generated at both ends of the low-temperature Curie point magnetic substance 3 in the d-2 direction, while also eliminating interaction between the two magnetic poles 6-5,6-6 of the rotor 5 and the magnetic field generated at both ends of the low-temperature Curie point magnetic substance 3 in the d-5 direction, thus facilitating, for example, 30 degree rotation of the rotor 5 as mentioned above.

In FIG. 4(d), after the two low-temperature Curie point magnetic substances 3 in the d-2 and d-5 directions have been heated, they naturally cool to near the low temperature (L), but a fluid such as cooling water may be used for forcible cooling of the two heated low-temperature Curie point magnetic substances to room temperature or to a lower temperature. This will allow a relatively large difference to be produced between the magnetic permeability of the low-temperature Curie point magnetic substance at high temperature (H) and the magnetic permeability of the low-temperature Curie point magnetic substance at low temperature (L), so that a more powerful rotating magnetic field can be generated on the inner side of the composite magnetic ring, compared to the case shown in FIG. 4(d).

According to this operating principle illustrated in FIG. 4(a)-(d), the low-temperature Curie point magnetic substances 3 to be heated are consecutively switched, while simultaneously, the non-heated low-temperature Curie point magnetic substances 3 (including the already heated low-temperature Curie point magnetic substances 3) are consecutively switched for natural cooling, to generate a rotating magnetic field that is continuous in the composite magnetic ring 1, allowing the rotor 5 to rotate continuously with the rotor 5 being capable of starting regardless of the positions of the magnetic poles of the rotor 5. As mentioned above, a fluid such as cooling water may be used for forcible cooling of the two heated low-temperature Curie point magnetic substances to room temperature or a lower temperature, instead of naturally cooling the heated low-temperature Curie point magnetic substances.

The thermomagnetic motors illustrated in FIG. 4(a)-(d) each comprise a stator having 12 magnetic poles composed of a composite magnetic ring in which 6 permanent magnets and 6 low-temperature Curie point magnetic substances are arranged in an alternating fashion, and a rotor having 8 magnetic poles situated inside the composite magnetic ring, and when the two low-temperature Curie point magnetic substances have been consecutively switched for heating every 60 degrees in the clockwise direction, symmetrically across the center of the composite magnetic ring, the rotor rotates 30 degrees each time in the counter-clockwise direction.

Also, when the two low-temperature Curie point magnetic substances have been consecutively switched for heating every 60 degrees in the counter-clockwise direction, symmetrically across the center of the composite magnetic ring, the rotor rotates 30 degrees each time in the clockwise direction.

Incidentally, in cases such as in FIG. 10 described hereunder, where the thermomagnetic motors each comprise a stator having 6 magnetic poles composed of a composite magnetic ring in which 3 permanent magnets (or 6 permanent magnets) and 3 low-temperature Curie point magnetic substances are arranged in an alternating fashion, a rotor having 4 magnetic poles situated inside the composite magnetic ring, the rotor rotates 60 degrees each time in the counter-clockwise direction after one low-temperature Curie point magnetic substance of the composite magnetic ring has been consecutively switched for heating every 120 degrees in the clockwise direction.

Also, when one low-temperature Curie point magnetic substance of the composite magnetic ring has been consecutively switched for heating every 120 degrees in the counter-clockwise direction, the rotor rotates 60 degrees each time in the clockwise direction.

Since a plurality of low-temperature Curie point magnetic substances and a plurality of permanent magnets are placed in an alternating arrangement forming a ring in the composite magnetic rings of the examples shown in FIG. 2 to FIG. 4, it is possible to evenly heat only the low-temperature Curie point magnetic substances that have been selected for heating, in a state separated from the other low-temperature Curie point magnetic substances. Consequently, heat loss due to flow of heat from the high temperature sections of the low-temperature Curie point magnetic substances which are selected for heating to the low temperature sections of the low-temperature Curie point magnetic substances that are naturally cooled to near room temperature, is notably reduced, and the efficiency for heating the low-temperature Curie point magnetic substances is increased. As a result, even with a very slight temperature difference (for example, 15° C.) between the high temperature sections (for example, 40° C.) and the low temperature sections (for example, room temperature (25° C.)) of the low-temperature Curie point magnetic substances, the temperature for the Curie point of the low-temperature Curie point magnetic substances may be appropriately set depending on this temperature difference, to provide a thermomagnetic motor in which the rotor rotates in a continuous manner.

In the composite magnetic rings of these examples, a low-cost barium ferrite magnet is used as the permanent magnet while similarly low-cost manganese-zinc ferrite is used as the low-temperature Curie point magnetic substance. As a result, it is possible to convert low-temperature exhaust heat energy and sunlight heat energy to mechanical energy or electrical energy at low cost and in an efficient manner, using a thermomagnetic motor or the like comprising such a composite magnetic ring.

Furthermore, in the composite magnetic rings of these examples, the construction is such that a heat-insulating material is sandwiched between each permanent magnet in the composite magnetic ring and the low-temperature Curie point magnetic substance adjacent to each permanent magnet, so that the low-temperature Curie point magnetic substance is isolated from the permanent magnet by the heat-insulating material. This eliminates heat flow from the high temperature sections of the low-temperature Curie point magnetic substances which are selected for heating, and the low temperature sections of the permanent magnets situated adjacent to those low-temperature Curie point magnetic substances, or of the other low-temperature Curie point magnetic substances, thereby minimizing heat loss.

As an alternative construction, narrow gaps may be provided at both ends of each low-temperature Curie point magnetic substance, instead of sandwiching heat-insulating materials between each permanent magnet and the low-temperature Curie point magnetic substances adjacent to the permanent magnet. In this type of construction as well, similar to the composite magnetic rings of the aforementioned examples, there is no direct contact between any ends of the plurality of permanent magnets or any ends of the plurality of low-temperature Curie point magnetic substances, and therefore flow of heat is prevented from the high temperature sections of the low-temperature Curie point magnetic substances that are heated to the low temperature sections of the permanent magnet situated adjacent to those low-temperature Curie point magnetic substances, or of the other low-temperature Curie point magnetic substances, thereby minimizing heat loss.

Furthermore, in the composite magnetic rings of these examples, soft magnetic material yokes can be sandwiched between each of the permanent magnets and low-temperature Curie point magnetic substances to reduce flux flowing out of the composite magnetic ring and increase flux flowing into the circle of the composite magnetic ring, and as a result, a more powerful magnetic field is generated on the inner side of the composite magnetic ring than without a yoke, and the rotational torque of the rotor can be increased.

In addition, in the composite magnetic ring of this example, at least one of the plurality of composite magnetic rings is heated by irradiation with sunlight to create high temperature sections in the composite magnetic ring, thereby allowing rotary electric power generation by solar heat. By using a low-cost barium ferrite magnet as the permanent magnet and low-cost manganese-zinc ferrite as the low-temperature Curie point magnetic substance, as mentioned above, it is possible to realize very low-cost solar thermal power generation.

In addition, in the composite magnetic ring of this example, at least one of the plurality of composite magnetic rings is heated by low-temperature exhaust heat energy to create high temperature sections in the composite magnetic ring, thereby allowing an extremely low-cost exhaust heat recovery system to be realized.

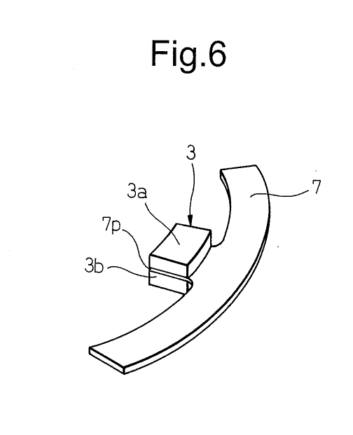

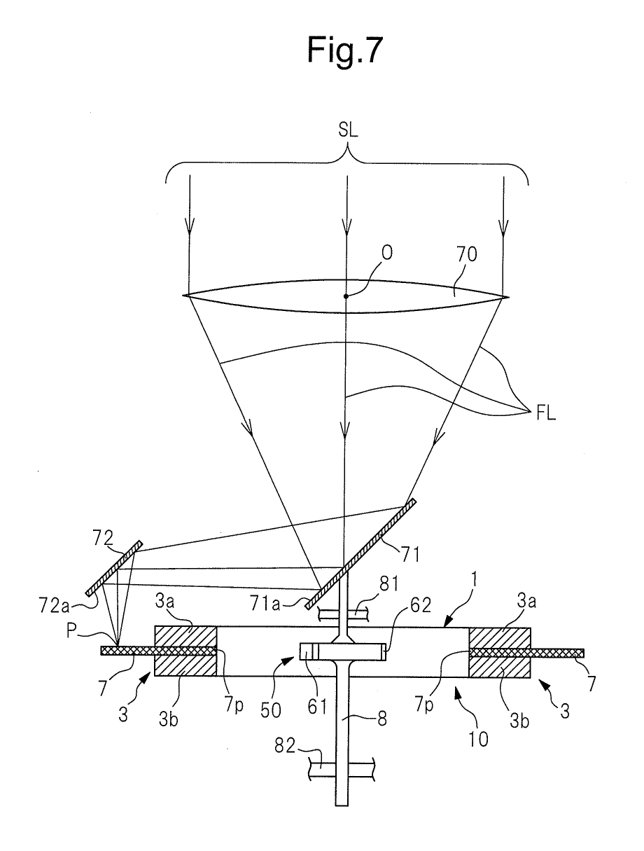

FIG. 5 is a perspective view of the overall structure of an example of a thermomagnetic motor of the invention, FIG. 6 is a perspective view showing the positional relationship between low-temperature Curie point magnetic substances and the absorber plate for the example of FIG. 5, and FIG. 7 is a front view showing the relationship between the sunlight collecting pathway and mirror for the example of FIG. 5. The energy converter according to this example of the invention is shown in a construction of a thermomagnetic motor for conversion of sunlight heat energy to mechanical energy.

In FIG. 5, the thermomagnetic motor of this example of the invention comprises a stator 10 composed of a composite magnetic ring 1 in which 6 pairs of low-temperature Curie point magnetic substances 3 made of manganese-zinc ferrite (Mn_{0.25}Zn_{0.75}Fe₂O₄) (that is, 6 upper low-temperature Curie point magnetic substances 3a and 6 lower low-temperature Curie point magnetic substances 3b), and 6 permanent magnets 2 made of barium ferrite or the like, are arranged in an alternating fashion. Also, a rotor 50 having two magnetic poles 61,62 (N-pole and S-pole) composed of rare earth magnets is situated at the center section of the stator 10. A rotating shaft 8 that rotates in cooperation with the rotor 50 is mounted on the rotor 50.

Also, in FIG. 5, a first mirror 71 with a first reflection surface 71a is anchored to the rotating shaft 8, tilted 45 degrees with respect to the rotating shaft of the rotor 50. In addition, a second mirror 72 having a second reflection surface 72a is situated protruding from the first mirror 71 in the direction perpendicular to the rotating shaft of the rotor 50, at a tilt of 45 degrees with respect to the rotating shaft of the rotor 50. The second mirror 72 is anchored to the first mirror 71 by a transparent box 73. A lens 70 for collection and directing of sunlight SL to the second mirror 72 is situated above the first mirror 71. Also, a plurality of absorber plates 7 each individually situated in contact with the plurality of low-temperature Curie point magnetic substances 3 are overhanging around the perimeter of the composite magnetic ring 1. Each absorber plate 7 is made of a material which is non-magnetic and has satisfactory thermal conductivity, such as Cu (copper). In order to prevent flow of heat from the high temperature sections to the low temperature sections, a slight spacing SP is formed between each absorber plate and the absorber plate adjacent to it. The first mirror 71, second mirror 72, transparent box 73 and lens 70 form an optical device that collects sunlight SL and irradiates it onto at least one absorber plate 7.

The light irradiated onto the surface of at least one absorber plate 7 by the optical device is converted to thermal energy by the absorber plate 7. The converted thermal energy is transmitted to the low-temperature Curie point magnetic substance 3 in contact with the absorber plate 7, and utilized to heat the low-temperature Curie point magnetic substance 3.

More specifically, the sunlight SL is collected by the lens 70 and focused toward a line connecting the center O of the lens 70 and the center of the first mirror 71. The light FL focused in this manner is reflected by the first reflection surface 71a of the first mirror 71 and the second reflection surface 72a of the second mirror 72, and intensively irradiated onto a spot P on the surface of any one of the absorber plates 7 overhanging from the perimeter of the composite magnetic ring 1. The light irradiated onto the spot P on the surface of the absorber plate 7 heats the absorber plate 7 to a high temperature (H), and the heat generated thereby causes the low-temperature Curie point magnetic substance 3 in contact with the absorber plate 7 to be heated to a temperature near the Curie point of the low-temperature Curie point magnetic substance 3. This method of heating the low-temperature Curie point magnetic substance is essentially the same as the heating method explained for FIG. 3(4) above (i.e., the method of heating only one low-temperature Curie point magnetic substance).

When the low-temperature Curie point magnetic substance 3 to be heated by the absorber plate 7 increases in temperature to near its Curie point, the magnetic permeability of the low-temperature Curie point magnetic substance 3 to be heated is altered to a relatively low value, as explained for FIG. 4(a)-(d) above, and the flux exiting the ends of the permanent magnet 2 situated adjacent to the low-temperature Curie point magnetic substance 3 leaks outside near the low-temperature Curie point magnetic substance 3. This flux forms a magnetic field at the location of the two magnetic poles 61,62 of the rotor 50 situated at the center of the composite magnetic ring 1. The magnetic field applies rotational torque to the rotor 50, causing the rotor 50 to rotate in the counter-clockwise direction.

Rotation of the rotor 50 occurs simultaneously with rotation of the first mirror 71 that is anchored to the rotating shaft 8 which rotates in cooperation with the rotor 50, as well as with rotation of the second mirror 72 that is anchored to the first mirror 71 by the transparent box 73, so that the spot P consecutively moves on the absorber plate 7. Thus, the low-temperature Curie point magnetic substance 3 to be heated is consecutively switched, and consecutive heating occurs to a temperature near the Curie point of that low-temperature Curie point magnetic substance 3. After the second mirror 72 has passed over the absorber plate 7 which was being heated, that absorber plate 7 naturally cools to near room temperature (25° C.) by the convection current of air.

As an alternative construction, a fluid such as cooling water may be used for forcible cooling of the heated absorber plate 7 and the low-temperature Curie point magnetic substance contacting with that absorber plate, to room temperature or a lower temperature. This will allow a relatively large difference to be produced between the magnetic permeability of the low-temperature Curie point magnetic substance to be heated and the magnetic permeability of the heated low-temperature Curie point magnetic substance, so that a more powerful rotating magnetic field can be generated on the inner side of the composite magnetic ring.

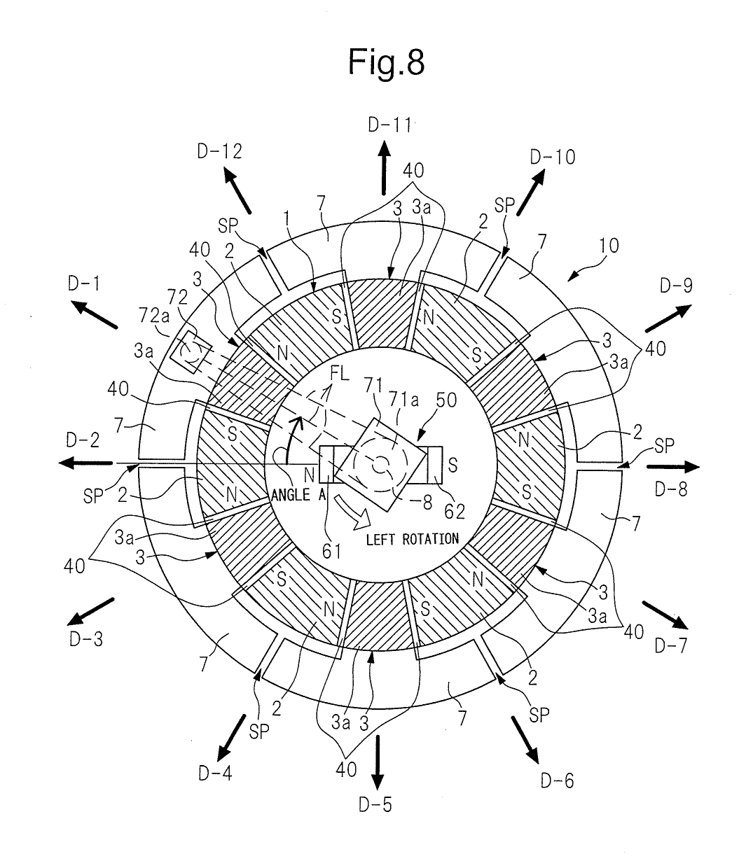

Furthermore, heat-insulating sheets such as thin Teflon® are sandwiched between each low-temperature Curie point magnetic substance 3 and the permanent magnets 2 adjacent to that low-temperature Curie point magnetic substance 3, in order to avoid heating of the permanent magnets 2 situated adjacent to the low-temperature Curie point magnetic substance 3 to be heated (the heat-insulating sheets are not shown in FIG. 5: see FIG. 8 explained below). The heat-insulating sheets can prevent flow of heat from the high temperature section of the low-temperature Curie point magnetic substance 3 to be heated to the permanent magnets 2 situated adjacent to that low-temperature Curie point magnetic substance 3.

As an alternative construction, narrow gaps may be provided at both ends of each low-temperature Curie point magnetic substance, instead of sandwiching heat-insulating sheets between each permanent magnet and the low-temperature Curie point magnetic substances adjacent to it. This type of construction also prevents direct contact between either edge of the plurality of permanent magnets and either edge of the plurality of low-temperature Curie point magnetic substances, similar to the composite magnetic ring of FIG. 5, and it is thereby possible to prevent flow of heat from the high temperature section of the low-temperature Curie point magnetic substance to be heated, toward the permanent magnets situated adjacent to that low-temperature Curie point magnetic substance.

As shown in FIG. 6, each low-temperature Curie point magnetic substance 3 is placed separately above and below the protrusion 7p formed on each absorber plate 7. More specifically, each upper low-temperature Curie point magnetic substance 3a is anchored in contact with the upper surface of each absorber plate 7, while each lower low-temperature Curie point magnetic substance 3b is anchored in contact with the lower surface of each absorber plate 7. This allows thermal contact between the upper low-temperature Curie point magnetic substance 3a, the lower low-temperature Curie point magnetic substance 3b and the absorber plate 7 to be satisfactorily maintained. Although the upper low-temperature Curie point magnetic substance 3a and lower low-temperature Curie point magnetic substance 3b are formed in a separated manner in this case, the upper low-temperature Curie point magnetic substance 3a and lower low-temperature Curie point magnetic substance 3b may instead be partially connected.

FIG. 7 shows an example of the relationship between the sunlight SL collecting pathway, the first mirror 71 and the second mirror 72 for the example of FIG. 5. As shown in FIG. 7, the sunlight SL is collected by the lens 70 and focused toward a line connecting the center O of the lens 70 and the center of the first mirror 71. The focused light FL is reflected by the first reflection surface 71a of the first mirror 71, changes its direction by 90 degrees and proceeds toward the second mirror 72. The focused light FL is reflected by the second reflection surface 72a of the second mirror 72, changes its direction by 90 degrees, and proceeds toward the surface of the desired absorber plate 7 overhanging around the perimeter of the composite magnetic ring 1. Finally, the focused light FL is intensively irradiated to a spot P on the surface of the absorber plate 7. The rotating shaft 8 for anchoring the first mirror 71 is linked to a first bearing 81 and a second bearing 82, and the mechanical energy of rotation of the rotor 50 is transmitted to the exterior of the thermomagnetic motor through the rotating shaft 8.

FIG. 8 is a plan view showing the state of a rotating rotor in the example of FIG. 5. In this case as well, the thermomagnetic motor comprises a stator 10 composed of a composite magnetic ring 1 in which 6 low-temperature Curie point magnetic substances 3 (only the 6 upper low-temperature Curie point magnetic substances 3a are shown in FIGS. 8) and 6 permanent magnets 2 are arranged in an alternating fashion, and a rotor 50 situated at the center section of the stator 10 and having 2 rectangular magnetic poles 61,62.

FIG. 8 shows an example of the relationship between the composite magnetic ring 1, rotor 50, first mirror 71 and second mirror 72. As shown in FIG. 8, the first mirror 71 and second mirror 72 are anchored with a shift of only angle A (for example, 30 degrees) between the direction connecting the two magnetic poles 61,62 of the rotor 50 and the direction connecting the first mirror 71 and second mirror 72, in order to heat the low-temperature Curie point magnetic substance 3 and apply rotational torque to the rotor 50.

In FIG. 8, the second mirror 72 is in the D-1 direction, the magnetic pole 61 of the N-pole of the rotor 50 is in the D-2 direction, and the magnetic pole 62 of the S-pole is in the D-8 direction. When sunlight is irradiated onto one absorber plate 7, the absorber plate 7 in the D-1 direction is heated. This causes the low-temperature Curie point magnetic substance 3 in the same direction to be heated, and the magnetic permeability of that low-temperature Curie point magnetic substance 3 is altered to a relatively low value. At this time, S-pole and N-pole magnetic poles are generated at both ends of the low-temperature Curie point magnetic substance 3, and a magnetic field is formed near the low-temperature Curie point magnetic substance 3. In this case, rotational torque is generated on the rotor 50, so that the orientation of the magnetic field formed by the S-pole and N-pole magnetic poles at both ends of the low-temperature Curie point magnetic substance 3 and the orientation of the magnetic field formed by the two magnetic poles 61,62 of the rotor 50, are approximately parallel, and in opposite directions (i.e., magnetostatic energy is minimized).

In FIG. 8, the rotational torque causes rotation of the rotor 50 by 60 degrees in the counter-clockwise direction. When the rotor 50 rotates 60 degrees, the rotor 50 becomes oriented so that the orientation of the magnetic field of the magnetic poles generated at both ends of the low-temperature Curie point magnetic substance 3 that is heated and the orientation of the magnetic field formed by the two magnetic poles 61,62 of the rotor 50 are approximately parallel and in opposite directions, and therefore the rotor 50 stops. However, the rotation of the rotor 50 causes the second mirror 72 to move over the absorber plate 7 located in the D-3 direction, whereby the temperatures of the absorber plate 7 in the D-3 direction and of the low-temperature Curie point magnetic substance 3 in contact with that absorber plate 7 increase, and S-pole and N-pole magnetic poles are generated at both ends of that low-temperature Curie point magnetic substance 3.

At the same time, the absorber plate 7 in the D-1 direction and the low-temperature Curie point magnetic substance 3 in contact with that absorber plate 7, which are no longer heated, fall in temperature and the magnetic permeability of that low-temperature Curie point magnetic substance 3 is altered to a relatively high value. Consequently, the magnetic poles generated on both sides of the low-temperature Curie point magnetic substance 3 are annihilated. As a result, there is no longer interaction between the two magnetic poles 61,62 of the rotor 50 and the magnetic field generated at both ends of the low-temperature Curie point magnetic substance 3 in the D-1 direction, such that 60 degree rotation of the rotor 50 is facilitated.

In FIG. 8, after the absorber plate 7 in the D-1 direction and the low-temperature Curie point magnetic substance 3 in contact with that absorber plate 7 have been heated, they naturally cool to near the room temperature, but a fluid such as cooling water may be used for forcible cooling of the heated absorber plate and the low-temperature Curie point magnetic substance in contact with that absorber plate, to room temperature or to a lower temperature. This will allow a relatively large difference to be produced between the magnetic permeability of the low-temperature Curie point magnetic substance to be heated and the magnetic permeability of the heated low-temperature Curie point magnetic substance, so that a more powerful rotating magnetic field can be generated on the inner side of the composite magnetic ring than in FIG. 8, to obtain more powerful rotational torque.

By repeating the steps described above, the absorber plates 7 in the D-5, D-7, D-9 and D-11 directions and the low-temperature Curie point magnetic substances 3 in contact with those absorber plates 7 are consecutively switched for heating, while simultaneously, the heated absorber plates 7 and the low-temperature Curie point magnetic substances 3 in contact with those absorber plates 7 are consecutively switched for natural cooling or forcible cooling, so that the rotor 50 undergoes continuous rotation. In the thermomagnetic motor shown in FIG. 8, when the second mirror 72 is in the D-2 direction and the diameter of the collecting spot P is larger than the width of the spacing SP between the absorber plates, the absorber plates 7 in the D-1 and D-3 directions in FIG. 8 are simultaneously heated, and the temperatures of the low-temperature Curie point magnetic substances 3 in the D-1 direction and D-3 direction increase while the magnetic permeabilities decrease, and therefore flux flows from the N-pole of the permanent magnet 2 in the D-12 direction toward the S-pole of the permanent magnet 2 in the D-4 direction, generating a powerful magnetic field. Since the N-pole magnetic pole 61 of the rotor 50 is in the D-3 direction and the S-pole magnetic pole 62 is in the D-9 direction at this time, rotational torque is generated on the rotor 50 in the counter-clockwise direction, causing the rotor 50 to rotate in the counter-clockwise direction. Consequently, the thermomagnetic motor shown in FIG. 8 can be driven whether the second mirror 72 is above the absorber plate 7 or whether it is above a spacing between absorber plates 7. Incidentally, the magnetic field generated by the S-pole and N-pole of the permanent magnet 2 in the D-2 direction is opposite to the direction of the magnetic field generated by the N-pole of the permanent magnet 2 in the D-12 direction and the S-pole of the permanent magnet 2 in the D-4 direction, but its strength is low and it has little effect.

In FIG. 8, a heat-insulating sheet 40 such as a thin Teflon® sheet is sandwiched between each low-temperature Curie point magnetic substance 3 and the permanent magnets 2 adjacent to that low-temperature Curie point magnetic substance 3, in order to avoid heating of the permanent magnets 2 situated adjacent to the low-temperature Curie point magnetic substance 3 that is heated. The heat-insulating sheets 40 can prevent flow of heat from the high temperature section of the low-temperature Curie point magnetic substance 3 that is heated to the permanent magnets 2 situated adjacent to that low-temperature Curie point magnetic substance 3.

In the thermomagnetic motor according to the example shown in FIG. 5 to FIG. 8, the stator 10 is composed of a composite magnetic ring 1 in which 6 pairs of low-temperature Curie point magnetic substances 3 and 6 permanent magnets 2 are arranged in an alternating fashion, but a composite magnetic ring constructed using any other number of low-temperature Curie point magnetic substances and permanent magnets may also be used as the stator. Also, the rotor with two magnetic poles is situated at the center section of the stator 10 in the thermomagnetic motor according to the example shown in FIG. 5 to FIG. 8, but a rotor having any other number of magnetic poles may be used instead. However, in the example of FIG. 5 to FIG. 8 as well, similar to FIG. 4, when the number of permanent magnets and the number of low-temperature Curie point magnetic substances of the stator are multiples of 3, the number of magnetic poles of the rotor is preferably not a multiple of 3. Conversely, when the number of magnetic poles of the rotor is a multiple of 3, the number of permanent magnets and the number of low-temperature Curie point magnetic substances of the stator are preferably not multiples of 3.

In addition, in the thermomagnetic motor according to the example shown in FIG. 5 to FIG. 8, a composite magnetic ring 1 having a plurality of low-temperature Curie point magnetic substances and a plurality of permanent magnets 2 arranged in an alternating fashion is used as the stator 10, and a rotor having a plurality of magnetic poles is situated at the center section of the stator 10, but in an alternate structure, the composite magnetic ring 1 may be rotated as the rotor and a stator having 2 or more magnetic poles may be situated at the center section of the rotor.

In the thermomagnetic motor of the example shown in FIG. 5 to FIG. 8 explained above, a composite magnetic ring having a plurality of low-temperature Curie point magnetic substances and a plurality of permanent magnets placed in an alternating arrangement forming a ring is used as the stator, and it is possible to evenly heat only the low-temperature Curie point magnetic substance that has been selected for heating, in a state separated from the other low-temperature Curie point magnetic substances. Consequently, heat loss due to flow of heat from the high temperature sections of the low-temperature Curie point magnetic substance which is heated to the low temperature sections of the low-temperature Curie point magnetic substances that are naturally cooled to near room temperature, is notably reduced, and the efficiency for heating the low-temperature Curie point magnetic substances is increased. As a result, even with a very slight temperature difference between the high temperature sections and the low temperature sections of the low-temperature Curie point magnetic substances, the temperature for the Curie point of the low-temperature Curie point magnetic substances may be appropriately set depending on this temperature difference, to provide a thermomagnetic motor in which the rotor rotates in a continuous manner.

Furthermore, in the thermomagnetic motor of this example, a low-cost barium ferrite magnet is used as the permanent magnet of the composite magnetic ring, while similarly low-cost manganese-zinc ferrite is used as the low-temperature Curie point magnetic substance of the composite magnetic ring. As a result, it is possible to convert low-temperature exhaust heat energy and sunlight heat energy to mechanical energy or electrical energy at low cost and in an efficient manner, using a thermomagnetic motor comprising such a composite magnetic ring.

Furthermore, in the thermomagnetic motor of this example, the construction is such that a heat-insulating sheet is sandwiched between each permanent magnet in the composite magnetic ring and the low-temperature Curie point magnetic substance adjacent to each permanent magnet, so that the low-temperature Curie point magnetic substance is isolated from the permanent magnet by the heat-insulating sheet. This eliminates heat flow from the high temperature sections of the low-temperature Curie point magnetic substance which is heated, and the low temperature sections of the permanent magnets situated adjacent to that low-temperature Curie point magnetic substance, or of the other low-temperature Curie point magnetic substances, thereby minimizing heat loss.

As an alternative construction, narrow gaps may be provided at both ends of each low-temperature Curie point magnetic substance, instead of sandwiching heat-insulating sheets between each permanent magnet and the low-temperature Curie point magnetic substances adjacent to the permanent magnet. In this type of construction as well, similar to the composite magnetic ring of the thermomagnetic motor of the aforementioned example, there is no direct contact between any ends of the plurality of permanent magnets or any ends of the plurality of low-temperature Curie point magnetic substances, and therefore flow of heat is prevented from the high temperature sections of the low-temperature Curie point magnetic substance that is heated to the low temperature sections of the permanent magnet situated adjacent to that low-temperature Curie point magnetic substance, or of the other low-temperature Curie point magnetic substances, thereby minimizing heat loss.

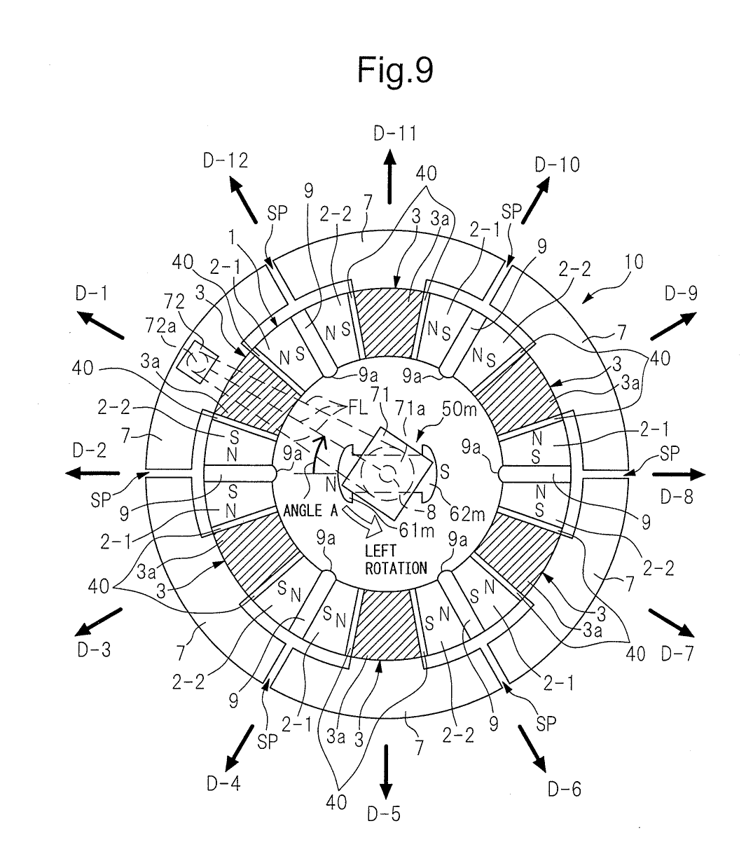

FIG. 9 is a plan view showing the overall construction of a modification of the example of FIG. 5. In this case as well, similar to the example of FIG. 5 described above, the thermomagnetic motor comprises a stator 10 composed of a composite magnetic ring 1 in which 6 pairs of low-temperature Curie point magnetic substances 3 (only the 6 upper low-temperature Curie point magnetic substances 3a are shown in FIG. 9) and 6 pairs of permanent magnets 2 are arranged in an alternating fashion, and a rotor 50m situated at the center section of the stator 10 and having two magnetic poles 61m, 62m (N-pole and S-pole).

The construction of the modified example in FIG. 9 is generally the same as the example shown in FIG. 8. However, the modified example of FIG. 9 differs from the example of FIG. 8 described above in that a yoke 9 of the soft magnetic material is formed at the center section of each permanent magnet (pair of permanent magnets 2-1, 2-2) and in that the magnetic poles 61m, 62m of the rotor have rounded shapes. Tip sections 9a are formed on the ends of the yokes 9, protruding in a circular arc form from the inner perimeter of the composite magnetic ring 1. The temperature of the Curie point of the yokes 9 is set to a much higher temperature than room temperature (25° C.).

The reason for forming tip sections 9a protruding in a circular arc form at the ends of each of the yokes 9, and the reason for the rounded shapes of the magnetic poles 61m, 62m of the rotor 50m, will now be explained. When a soft magnetic material yoke 9 is formed at the center section of each pair of permanent magnets 2-1,2-2, a portion of the flux generated by the magnetic poles of the pair of permanent magnets 2-1,2-2 exits through the tip section 9a of the corresponding yoke 9. If, in order to generate a large rotational torque by the rotor 50m, the tip sections 9a protruding from the yokes 9 are made rectangular, or largely protruding, or the two magnetic poles 61m, 62m of the rotor 50m are made rectangular, the magnetic interaction is excessively strong between the magnetic poles 61m, 62m and the two yokes located on either side of each of the magnetic poles 61m, 62m of the rotor 50m, potentially resulting in excessively strong cogging of the rotor 50m. The rotor 50m may therefore fail to rotate in some cases. In order to avoid this situation, each of the tip sections 9a of the yokes 9 are formed as circular arcs and their protruding lengths are adjusted, while the magnetic poles 61m, 62m of the rotor are also formed as rounded shapes, so that magnetic interaction between the magnetic poles 61m, 62m and the two yokes located on either side of each of the magnetic poles 61m, 62m of the rotor 50m in FIG. 9 can be appropriately attenuated.

In FIG. 9, the second mirror 72 is in the D-1 direction, the magnetic pole 61m of the N-pole of the rotor 50m is in the D-2 direction, and the magnetic pole 62m of the S-pole is in the D-8 direction. When sunlight is irradiated onto one absorber plate 7, the absorber plate 7 in the D-1 direction is heated. This causes the low-temperature Curie point magnetic substance 3 in the same direction to be heated, and the magnetic permeability of that low-temperature Curie point magnetic substance 3 is altered to a relatively low value. At this time, S-pole and N-pole magnetic poles are generated at both ends of the low-temperature Curie point magnetic substance 3, and a magnetic field is formed near the low-temperature Curie point magnetic substance 3. In addition, a portion of the flux generated by the magnetic poles of the pair of permanent magnets 2-1,2-2 in the D-12 direction exits through the tip section 9a of the corresponding yoke 9. In addition, the magnetic field due to flux generated by the magnetic poles of the pair of permanent magnets 2-1,2-2 in the D-2 direction exits through the tip section 9a of the corresponding yoke 9. Thus, since the magnetic fields for flux exiting through the tip sections 9a of the two yokes 9 are added to the magnetic field formed near the low-temperature Curie point magnetic substance 3 in the D-1 direction, a larger magnetic field than in the example of FIG. 8 magnetically interacts with the magnetic field formed by the two magnetic poles 61m, 62m of the rotor 50m. Consequently, a greater rotational torque is generated on the rotor 50m than in the example shown in FIG. 8. As a result, the rotor 50m rotates more stably than in the example of FIG. 8, and sunlight heat energy can be converted to mechanical energy more efficiently than in the example of FIG. 8.

In FIG. 9, the rotational torque causes rotation of the rotor 50m by 60 degrees in the counter-clockwise direction. When the rotor 50m rotates 60 degrees, the rotor 50m becomes oriented so that the orientation of the magnetic field of the magnetic poles generated at both ends of the low-temperature Curie point magnetic substance 3 that is heated and the orientation of the magnetic field formed by the two magnetic poles 61m, 62m of the rotor 50m are approximately parallel and in opposite directions, and therefore the rotor 50m stops. However rotation of the rotor 50m causes the second mirror 72 to move over the absorber plate 7 located in the D-3 direction. This causes the temperatures of the absorber plate 7 in the D-3 direction and of the low-temperature Curie point magnetic substance 3 in contact with that absorber plate 7 to increase, and S-pole and N-pole magnetic poles are generated at both ends of that low-temperature Curie point magnetic substance 3. In addition, a portion of the flux generated by the magnetic poles of the pair of permanent magnets 2-1,2-2 in the D-2 direction exits through the tip section 9a of the corresponding yoke 9. A portion of the flux generated by the magnetic poles of the pair of permanent magnets 2-1,2-2 in the D-4 direction also exits through the tip section 9a of the corresponding yoke 9. Thus, since the magnetic fields for flux exiting through the tip sections 9a of the two yokes 9 are added to the magnetic field formed near the low-temperature Curie point magnetic substance 3 in the D-3 direction, a larger magnetic field than in the example of FIG. 8 magnetically interacts with the magnetic field formed by the two magnetic poles 61m, 62m of the rotor 50m.

At the same time, the absorber plate 7 in the D-1 direction and the low-temperature Curie point magnetic substance 3 in contact with that absorber plate 7, which are no longer heated, fall in temperature and the magnetic permeability of that low-temperature Curie point magnetic substance 3 is altered to a relatively high value. Consequently, the magnetic poles generated on both sides of the low-temperature Curie point magnetic substance 3 are annihilated. As a result, there is no longer interaction between the two magnetic poles 61m, 62m of the rotor 50m and the magnetic field generated at both ends of the low-temperature Curie point magnetic substance 3 in the D-1 direction, and 60 degree rotation of the rotor 50m is facilitated.

By repeating the steps described above, the absorber plates 7 in the D-5, D-7, D-9 and D-11 directions and the low-temperature Curie point magnetic substances 3 in contact with those absorber plates 7 are consecutively switched for heating, similar to the example shown in FIG. 8, while simultaneously, the heated absorber plates 7 and the low-temperature Curie point magnetic substances 3 in contact with those absorber plates 7 are consecutively switched for natural cooling or forcible cooling, so that the rotor 50m undergoes stable continuous rotation.

In the thermomagnetic motor according to the modified example shown in FIG. 9, the stator 10 is composed of a composite magnetic ring 1 in which 6 pairs of low-temperature Curie point magnetic substances 3 and 6 pairs of permanent magnets 2 are arranged in an alternating fashion, but a composite magnetic ring constructed using any other number of low-temperature Curie point magnetic substances and permanent magnets may also be used as the stator. Also, the rotor with two magnetic poles is situated at the center section of the stator 10 in the thermomagnetic motor according to the modified example shown in FIG. 9, but a rotor having any other number of magnetic poles may be used instead. However, in the modified example of FIG. 9 as well, similar to the examples shown in FIG. 5 to FIG. 8, when the number of permanent magnets and the number of low-temperature Curie point magnetic substances of the stator are multiples of 3, the number of magnetic poles of the rotor is preferably not a multiple of 3. Conversely, when the number of magnetic poles of the rotor is a multiple of 3, the number of permanent magnets and the number of low-temperature Curie point magnetic substances of the stator are preferably not multiples of 3.

FIG. 10 is a diagram showing the operating principle of a modified example of the thermomagnetic motor of FIG. 4. The following explanation concerns a modified example of a thermomagnetic motor comprising a stator 10 having 6 magnetic poles composed of a composite magnetic ring in which 3 low-temperature Curie point magnetic substances 3 and 6 permanent magnets 2-1,2-2 are arranged in an alternating fashion, and a rotor 5 situated inside the composite magnetic ring and having 4 magnetic poles. Up to this point, the stator used comprised a circular composite magnetic ring with a plurality of permanent magnets and a plurality of low-temperature Curie point magnetic substances placed in an alternating arrangement forming a ring, but as shown in FIG. 10, for example, a thermomagnetic motor having essentially the same function as the thermomagnetic motor shown in FIG. 4 can be produced without the shape of the composite magnetic ring necessarily being circular (for example, the shape of the composite magnetic ring may be polygonal, such as triangular or hexagonal).

As shown in FIG. 10(a)-(d), a roughly regular triangular composite magnetic ring is formed from 3 low-temperature Curie point magnetic substances 3, 6 permanent magnets 2-1,2-2, 3 yokes 9-2 extending inward between each pair of adjacent permanent magnets, and 6 yokes 9-1,9-3 provided merely to direct flux.

More specifically, pure iron yokes 9-2 extend inward as shown in FIG. 10, in order to direct as much flux as possible from the composite magnetic ring toward the vicinity of the rotor 5, and form a powerful rotating magnetic field. The permanent magnets 2-1,2-2 are also bent inward from where their positions would be if the composite magnetic ring shape were circular. This reduces the volume of the device comprising the thermomagnetic motor and allows the low-temperature Curie point magnetic substances 3 and rotor 5 to be further separated, thus providing the advantage of facilitating equipment design for heating and cooling.

The operating principle for rotational operation of a thermomagnetic motor according to, for example, the heating method shown in FIG. 3(4) (that is, a method of heating only one low-temperature Curie point magnetic substance) will now be explained with reference to FIG. 10(a)-(d).

In FIG. 10(a), when all 3 low-temperature Curie point magnetic substances 3 are at low temperature, flux passes through the composite magnetic ring and does not exit to the outside. When the low-temperature Curie point magnetic substance 3 in the DD-1 direction is heated, the magnetic circuit is cut off, and therefore a portion of the flux directed from the N-pole of the magnet 2-2 in the DD-2 direction toward the S-pole of the magnet 2-1 in the DD-6 direction leaks to the inner side of the composite magnetic ring, but the effect is minimal since it is further away from the magnetic poles of the rotor 5.

At the same time, flux directed from the yoke 9-2 in the DD-2 direction toward the yoke 9-2 in the DD-6 direction is generated on the inner side of the composite magnetic ring. This flux passes through the yoke 9-2, permanent magnet 2-2 and yoke 9-3 in the DD-6 direction, further passes through the low-temperature Curie point magnetic substance 3 in the DD-5 direction, further passes through the yoke 9-1, permanent magnet 2-1, yoke 9-2, permanent magnet 2-2 and yoke 9-3 in the DD-4 direction, further passes through the low-temperature Curie point magnetic substance 3 in the DD-3 direction, further passes through the yoke 9-1 and permanent magnet 2-1 in the DD-2 direction, and reaches the yoke 9-2 in the DD-2 direction, thereby being circulated. Along with this flux, a magnetic field is generated between the yoke 9-2 in the DD-2 direction and the yoke 9-2 in the DD-6 direction, so that the N-pole magnetic pole 60-1 and the S-pole magnetic pole 60-2 of the rotor 5 are subjected to magnetic force, whereby the rotor 5 slightly rotates in the counter-clockwise, and stops.

Next, as shown in FIG. 10(b), when the low-temperature Curie point magnetic substance 3 in the DD-1 direction is at low temperature and the low-temperature Curie point magnetic substance 3 in the DD-5 direction is heated, a magnetic field is generated between the yoke 9-2 in the DD-6 direction and the yoke 9-2 in the DD-4 direction, so that the N-pole magnetic pole 60-3 and the S-pole magnetic pole 60-4 of the rotor 5 are subjected to magnetic force, whereby the rotor 5 rotates by a prescribed angle (for example, 60 degrees) in the counter-clockwise direction. FIG. 10(b) shows the position of the rotor of FIG. 10(a) after it has rotated by the prescribed angle.

Also, as shown in FIG. 10(c), when the low-temperature Curie point magnetic substance 3 in the DD-5 direction is at low temperature and the low-temperature Curie point magnetic substance 3 in the DD-3 direction is heated, a magnetic field is generated between the yoke 9-2 in the DD-4 direction and the yoke 9-2 in the DD-2 direction, so that the N-pole magnetic pole 60-1 and the S-pole magnetic pole 60-2 of the rotor 5 are subjected to magnetic force, whereby the rotor 5 rotates by a prescribed angle (for example, 60 degrees) in the counter-clockwise direction. FIG. 10(c) shows the position of the rotor of FIG. 10(b) after it has rotated by the prescribed angle.

Also, as shown in FIG. 10(d), when the low-temperature Curie point magnetic substance 3 in the DD-3 direction is at low temperature and the low-temperature Curie point magnetic substance 3 in the DD-1 direction is heated, a magnetic field is generated between the yoke 9-2 in the DD-2 direction and the yoke 9-2 in the DD-6 direction, so that the N-pole magnetic pole 60-3 and the S-pole magnetic pole 60-4 of the rotor 5 are subjected to magnetic force, whereby the rotor 5 rotates by a prescribed angle (for example, 60 degrees) in the counter-clockwise direction. FIG. 10(d) shows the position of the rotor of FIG. 10(c) after it has rotated by the prescribed angle.

The low-temperature Curie point magnetic substance 3 in the DD-5 direction, the low-temperature Curie point magnetic substance 3 in the DD-3 direction and the low-temperature Curie point magnetic substance 3 in the DD-1 direction are then consecutively heated in that order, producing continuous rotation.

By modifying the shape of the composite magnetic ring in the thermomagnetic motor of FIG. 10 from a circular form to a regular polygonal form (for example, regular triangular), as mentioned above, it is possible to create a more powerful rotating magnetic field near the rotor. Furthermore, since the low-temperature Curie point magnetic substance can be situated at a position further away from the rotor, it is possible to prevent problems resulting when a portion of the heat which heats the low-temperature Curie point magnetic substance is transmitted to the rotor generating a temperature distribution in the rotor. The volume of the device can also be reduced compared to a circular shape for the composite magnetic ring. In addition, if the shape of the composite magnetic ring is modified to be a regular polygonal shape, it is possible to produce a stator by straight line machining alone, thus facilitating production of the stator compared to a circular shape for the composite magnetic ring.

Nevertheless, in the thermomagnetic motor of FIG. 10, the rotor is attracted in the direction of the heated low-temperature Curie point magnetic substance, and therefore a load is applied to the rotor bearing. However, in a thermomagnetic motor comprising a stator with 12 magnetic poles and a rotor with 8 magnetic poles as shown in FIG. 4, low-temperature Curie point magnetic substances at 2 symmetrical locations are heated, and therefore the transverse force applied to the rotor bearing is canceled out to zero (0), so that the load on the bearing is alleviated.

### INDUSTRIAL APPLICABILITY

The present invention can be applied in an energy converter such as a thermomagnetic motor or solar thermal power generator for efficient conversion of low-temperature exhaust heat energy or sunlight heat energy at up to 100° C., to mechanical energy or electrical energy, utilizing variation in the magnetic permeabilities of low-temperature Curie point magnetic substances near their Curie points, in a composite magnetic ring formed by alternating arrangement of a plurality of low-temperature Curie point magnetic substances and a plurality of permanent magnets.

### EXPLANATION OF SYMBOLS

1 Composite magnetic ring

2 Permanent magnet

2-1,2-2 Permanent magnets

3 Low-temperature Curie point magnetic substance

3a Upper low-temperature Curie point magnetic substance

3b Lower low-temperature Curie point magnetic substance

4 Heat-insulating material

5 Rotor

6-1-6-8 Magnetic poles

7 Absorber plate

7p Protrusion

8 Rotating shaft

9 Yoke

9a Tip section

10 Stator

40 Heat-insulating sheet

50 Rotor

50m Rotor

61,62 Magnetic poles

61m, 62m Magnetic poles

70 Lens

71 First mirror

71a First reflection surface

72 Second mirror

72a Second reflection surface

73 Transparent box

81 First bearing

82 Second bearing

1. A composite magnetic ring having a construction wherein a plurality of permanent magnets are arranged in a ring shape at a prescribed spacing, and low-temperature Curie point magnetic substances having a Curie point at low temperature are sandwiched between each 2 adjacent permanent magnets, so that the plurality of permanent magnets and the plurality of low-temperature Curie point magnetic substances are situated in an alternating arrangement forming a ring.

2. A composite magnetic ring according to claim 1, wherein a heat-insulating material is sandwiched between each permanent magnet and the low-temperature Curie point magnetic substance adjacent to that permanent magnet.

3. A composite magnetic ring according to claim 1, wherein at least one of the low-temperature Curie point magnetic substances is heated at a temperature near the Curie point of the low-temperature Curie point magnetic substance, and the magnetic permeability of the low-temperature Curie point magnetic substance is altered, thereby generating a magnetic field in the vicinity of the low-temperature Curie point magnetic substance.

4. A composite magnetic ring according to claim 3, wherein the low-temperature Curie point magnetic substance to be heated is switched in consecutive order for heating while the low-temperature Curie point magnetic substances other than the one to be heated are switched in consecutive order for cooling, thereby generating a rotating magnetic field inside the composite magnetic ring.

5. An energy converter having a construction comprising:
a composite magnetic ring in which a plurality of permanent magnets are arranged in a ring shape at a prescribed spacing, and low-temperature Curie point magnetic substances having a Curie point at low temperature are sandwiched between each 2 adjacent permanent magnets, so that the plurality of permanent magnets and the plurality of low-temperature Curie point magnetic substances are situated in an alternating arrangement forming a ring, and
a rotor situated inside the composite magnetic ring and having a plurality of magnetic poles,
wherein at least one low-temperature Curie point magnetic substance in the composite magnetic ring is heated to a temperature near the Curie point of the low-temperature Curie point magnetic substance, and the magnetic permeability of the low-temperature Curie point magnetic substance is altered, thereby generating a magnetic field in the vicinity of the low-temperature Curie point magnetic substance, to cause rotation of the rotor.

6. An energy converter according to claim 5, wherein a heat-insulating material is sandwiched between each permanent magnet and the low-temperature Curie point magnetic substance adjacent to that permanent magnet.

7. An energy converter according to claim 5, wherein the low-temperature Curie point magnetic substance to be heated is switched in consecutive order for heating in cooperation with the rotor, while the low-temperature Curie point magnetic substances other than the one to be heated are switched in consecutive order for cooling, so that the rotor rotates in a continuous manner.

8. An energy converter having a construction comprising:
a composite magnetic ring in which a plurality of permanent magnets are arranged in a ring shape at a prescribed spacing, and low-temperature Curie point magnetic substances having a Curie point at low temperature are sandwiched between each 2 adjacent permanent magnets, so that the plurality of permanent magnets and the plurality of low-temperature Curie point magnetic substances are situated in an alternating arrangement forming a ring,
a rotor situated inside the composite magnetic ring and having a plurality of magnetic poles, and
heating means that heats at least one low-temperature Curie point magnetic substance in the composite magnetic ring,
wherein at least one low-temperature Curie point magnetic substance in the composite magnetic ring is heated to a temperature near the Curie point of the low-temperature Curie point magnetic substance by the heating means, and the magnetic permeability of the low-temperature Curie point magnetic substance is altered, thereby generating a magnetic field in the vicinity of the low-temperature Curie point magnetic substance, to cause rotation of the rotor.

9. An energy converter according to claim 8, wherein a heat-insulating material is sandwiched between each permanent magnet and the low-temperature Curie point magnetic substance adjacent to that permanent magnet.

10. An energy converter according to claim 8, wherein the low-temperature Curie point magnetic substance to be heated is switched in consecutive order for heating in cooperation with the rotor, while the low-temperature Curie point magnetic substances other than the one to be heated are switched in consecutive order for cooling, so that the rotor rotates in a continuous manner.
